(19) United States
(12) Patent Application Publication
(10) Pub. No.: US 2014/0081657 A1
(43) Pub. Date: Mar. 20, 2014

(54) Apparatus and Methods for Storage and Transfer of Patient Information Using Biological Sample Cards with Short Range Communications

(71) Applicants: WALLAC OY, Turku (FI); PERKINELMER HEALTH SCIENCES, INC., Waltham, MA (US)

(72) Inventors: Teppo Neuvonen, Kaarina (FI); Sami Rantala, Preitila (FI); Grant Gaillard, Greenville, SC (US); Curt Paulette, Akron, OH (US)

(73) Assignees: PerkinElmer Health Sciences, Inc., Waltham, MA (US); Wallac Oy, Turku (FI)

(21) Appl. No.: 13/622,317

(22) Filed: Sep. 18, 2012

(51) Int. Cl. G06F 19/00

(52) U.S. Cl. CPC G06F 19/323
USPC 705/3

(57) ABSTRACT

Described herein are methods and apparatus for storing and transferring patient information related to biological sample testing using biological sample cards and short range communications. In certain embodiments, the disclosed technology provides for the localized data transfer with biological sample cards equipped with a transmission and storage device that is capable of storing data such as patient information so that errors associated with manually entering handwritten patient information are reduced. The transmission and storage device may include a radio frequency identification (RFID) tag/chip such as a near field communication (NFC) tag/chip.

### BACKGROUND

Newborn infants are commonly screened shortly after birth for a variety of conditions via blood testing, particularly using Dried Blood Spot (DBS) cards. Newborn screening programs are often implemented on a national scale, and they target treatable conditions with the goal of detecting diseases before irreversible damage is done. Typically, newborn screening requires blood samples to be taken from a newborn and sent to one of four hundred screening laboratories worldwide for processing. Newborn screening programs collect blood samples using a specialized filter paper on a Dried Blood Spot (DBS) card. Blood samples are typically collected by pricking a newborn baby's heel and placing the blood samples on the filter paper portion of the DBS card.

Blood samples may be collected at a variety of times and under a variety of conditions. For example, in the United States, the blood samples are usually collected from the newborn at a medical facility, such as a hospital or doctor's office, twenty-four to forty-eight hours after birth. In other countries, such as the United Kingdom, blood samples are collected five to eight days after birth. The later samples, may be collected by midwives or other medical staff at a location other than a medical facility. The medical staff collecting the sample, in these circumstances, may differ from the medical staff attending to the birth and/or follow up care of the infant. Thus, the medical facility associated with care of the infant may fail to be alerted regarding collection of the sample.

The filter paper used for collection of the sample is often attached to a form on which patient information has been entered (e.g., typed, applied by a label, or most often handwritten). The filter paper portion and the form portion make up the “blood card”. The types of blood cards used may vary between hospitals, medical facilities, and/or regions. For example, the arrangement of the information, the particular fields presented on the blood card, and/or the labeling of the fields (e.g., names provided for identification of particular information, font, font size, etc.) vary based upon the regional rules and regulations.

The information entered on the blood card is later entered into the computer system of a testing laboratory and, often, a hospital, through a manual or semi-automatic (e.g., optical character recognition (OCR) followed by staff review) process. Due to variations in blood cards, the transfer of information between the blood card and the computer system can be prone to difficulties and/or errors. For example, in the event that handwritten information is unclear or otherwise difficult to read, errors can result when transferring the information to the computer system. If entered separately into both a hospital system and a laboratory system, errors can be replicated or a mismatch in patient data can occur.

Oftentimes, a number of samples are collected during a particular period of time (e.g., one day, one shift, etc.), and the batch of samples are then sent to a testing laboratory for processing. Upon receipt of the blood card, the testing laboratory may review the portions containing patient data (e.g., manually, semi-automatically, OCR, etc.) to compare to an inventory list provided by the medical facility. The portions containing patient data are provided for entry into the computer system, along with the unique identifier.

At the point of testing, the unique identifier on the filter paper portion may be scanned or otherwise entered into the computer system to be associated with the entered patient data. Based upon the associated patient data, the computer system can determine one or more required tests. Oftentimes, numerous factors derived from the patient information are considered in determining which tests to conduct. These factors may include demographic information as well as the present state of the infant (e.g., whether the baby is sick, premature, using steroids, or using antibiotics).

The tests conducted may further be based on whether this is the first screening of the infant or a repeat screening. In entering patient data into the computer system, for example, the testing laboratory may identify the blood sample as being linked to previous testing (e.g., abnormal test results or an unusable sample). Linking of a current sample to a previously received sample may be hindered, in some cases, due to discrepancies in information. For example, a misspelling may have occurred previously when entering the name of the infant, or the infant's name may have changed between the date of birth (e.g. “Baby Jones”) and the date of collection of the follow up sample (e.g., “Candace Jones”). In this circumstance, there is the possibility that proper tests will not be performed due to lack of recognition of the patient.

There are a number of inefficiencies associated with current methods and apparatus for obtaining and testing biological samples, particularly those involving blood cards. There is a need for improved efficiency in obtaining biological samples and conducting tests on those samples.

### SUMMARY

Described herein are methods and apparatus for storing and transferring patient information related to biological sample testing using biological sample cards and short range communications. In certain embodiments, the disclosed technology provides for the localized data transfer with biological sample cards equipped with a transmission and storage device that is capable of storing data such as patient information so that errors associated with manually entering handwritten patient information are reduced. The transmission and storage device may include a radio frequency identification (RFID) tag/chip such as a near field communication (NFC) tag/chip. In some examples, the biological samples include blood samples for newborn infant screening, cellular samples for genetics screening, blood/urine samples for drug use screening, or tissue samples for disease screening. Patient information is collected and associated with the biological sample. In certain embodiments, the disclosed technology reduces labor and improves efficiency and accuracy related to data entry.

Data may be transferred, in certain embodiments, to or from these biological sample cards when the biological sample cards are brought within a specified range of a computing device with short range communication capability. In other embodiments, data may be transferred to or from these biological sample cards when the biological sample cards are tapped against the computing device with short range communication capability. Data transfer, in some examples, involves the use of a software application executing upon a handheld computing device. For example, a software application for downloading patient data to the transmission and storage device of a biological sample card may include a user interface for inputting patient data and a routine for interfacing with a short range communications feature of a computing device, such as an RFID reader/writer, a Bluetooth® communicator, or a Wi-Fi™ communicator.

The disclosed technology, in certain embodiments, provides a network environment for sharing information between a medical facility and a testing laboratory. Information, including patient and sample collection information, may be associated with a unique identifier and stored on the network. In some implementations, when a party provides the unique identifier to a data center on the network environment, the party is provided with information associated with the unique identifier they provided to the data center. For example, the testing laboratory may obtain the unique identifier from a biological sample card and send the unique identifier to the data center. In response, the data center may provide information associated with that unique identifier to the testing laboratory. The testing laboratory may use the information to determine what tests to run on a biological sample associated with the unique identifier. In certain embodiments, the testing laboratory may also provide status alerts and updates to the data center using the unique identifier and the data center can relay these alerts to the medical facility or appropriate contact.

The biological sample cards, in certain embodiments, include a machine-readable indicia. In some implementations, the machine-readable indicia is presented on a biological sample card for stably storing the biological sample collected from a patient. The machine-readable indicia may include data related to a medical facility, a type of biological sample, the unique identifier, and/or sample collection data. Medical facilities and screening laboratories may obtain the unique identifier for a given biological sample card by scanning the machine-readable indicia.

One feature of the disclosed technology, in certain embodiments, is the storage of encrypted or secure patient information on the transmission and storage device. Moreover, securing or encrypting the data stored on the biological sample cards reduces legal and privacy concerns related to patient information.

The disclosed technology provides a user-friendly method and apparatus that can reduce errors and shorten intake time when retrieving patient data associated with a biological sample, thus increasing the efficiency of the sample testing process. Once the biological sample card is loaded with data such as patient information and biological samples have been collected and stably contained therein, the biological sample card is sent to a testing laboratory. In certain embodiments, when the testing laboratory receives the biological sample card, laboratory staff members may electronically transfer the data from the biological sample card to the laboratory computer system without having to manually enter the data or read a handwritten biological sample card. As such, this reduces errors associated with reading and transcribing handwritten information. Additionally, in some implementations, the medical facility collecting the biological sample may upload the patient data to a computer system associated with the medical facility and/or download patient data from a computer system associated with the medical facility to the transmission and storage device of the biological sample card. Thus, both the laboratory computer system and the medical facility computer system may maintain identical patient identification data.

The disclosed technology, in some implementations, improves communication between hospitals and screening laboratories. For example, the hospital computer system may use the information shared between the hospital and testing laboratory to track the status of a biological sample card and any tests associated with the biological sample card. Status updates may include whether the sample was received, whether the sample has been taken, whether the sample is abnormal, what tests are being performed, the tests results, and follow-up activities related to the patient's diagnosis.

In certain embodiments, the disclosed technology also provides medical facilities information regarding collection of biological samples such as newborn infant screening samples. When the newborn blood sample is collected outside of the hospital or other medical facility (e.g., home birth, midwife visit, etc.), for example, the medical facility may more accurately monitor when the sample has been collected and the identification of the staff member who collected the sample.

Furthermore, the disclosed technology can aid in reducing retest delay that can occur between the point at which a testing laboratory determines that a new sample needs to be obtained prior to further testing and the collection of the follow-up samples. For example, a medical facility may be quickly alerted when an unusable sample has been provided or when abnormal results require follow-on testing through automated status updates. Upon receipt of a follow-on biological sample, in some implementations, the patient data electronically obtained from the transmission and storage device of the follow-on biological sample card can be automatically compared to existing patient data in the laboratory computer system to link re-testing samples with previous test information. In another example, retest information can be provided within the patient data stored within the transmission and storage device of the biological sample card.

In certain embodiments, the testing laboratory may use a biological sample punching device to extract blood samples from the filter paper of a biological sample card. Reading apparatus for obtaining information from the transmission and storage device of a biological sample card, for example, may be located adjacent to or built into the biological sample punching device, biological sample testing instrument, or testing laboratory computing device. Blood cards may be punched differently depending on the patient information. A processor can obtain patient data from the transmission and storage device of the blood card and provide punching instructions to either the operator of the biological sample punching device or the setup control system of the biological sample punching device. The punching instructions, for example, may be based on one or more factors derived from the patient information.

In one aspect, the invention is directed to a biological sample card including: one or more collection regions, each configured to stably contain a biological sample; and a transmission and storage device including: an antenna configured for short range communication, and a computer-readable medium, wherein the transmission and storage device is configured to: receive patient data transmitted to the antenna, store the patient data in the computer-readable medium, and transmit the patient data via the antenna responsive to a query signal.

In certain embodiments, the biological sample card further includes a barcode, wherein the transmission and storage device is programmed with a barcode identifier corresponding to the barcode. In certain embodiments, the transmission and storage device is further configured to encrypt the patient data. In certain embodiments, the one or more collection regions includes filter paper configured to absorb the biological sample, wherein the biological sample includes a blood sample. In certain embodiments, the patient data is stored in XML format. In certain embodiments, transmitting the patient data includes encrypting the patient data.

In certain embodiments, the biological sample card includes a perforation configured to allow separation of a first portion of the biological sample card from a second portion of the biological sample card. In certain embodiments, the biological sample card includes a first barcode presented upon the first portion and a second barcode presented upon the second portion, wherein the first barcode is identical to the second barcode; and the transmission and storage device is programmed with a barcode identifier corresponding to the first barcode. In certain embodiments, the first portion includes the one or more collection regions and the transmission and storage device. In certain embodiments, the second portion includes one or more entry fields, wherein each of the entry fields is labeled to accept text information, wherein the text information includes a non-electronic rendering of at least a portion of the patient data.

In certain embodiments, the transmission and storage device includes an RFID tag. In certain embodiments, the transmission and storage device includes an NFC tag.

In another aspect, the invention is directed to a method including: obtaining patient data; initiating, by a processor of a computing device, communication with a transmission and storage device contained within or upon a biological sample card, wherein the transmission and storage device is configured for short range communication; transmitting, via an antenna of the computing device, the patient data from the computing device to the transmission and storage device, wherein the antenna is configured for short range communication; and verifying, by the processor of the computing device, success of transmission of the patient data.

In certain embodiments, the computing device is a handheld computing device. In certain embodiments, obtaining patient data includes receiving input manually entered on the computing device. In certain embodiments, obtaining patient data includes remotely receiving at least a portion of the patient data from a patient database system. In certain embodiments, obtaining patient data includes scanning a computer-readable indicia with a scanner of the computing device. In certain embodiments, initiating communication with the transmission and storage device includes tapping the biological sample card to the computing device. In certain embodiments, the transmission and storage device includes an RFID tag. In certain embodiments, the transmission and storage device includes an NFC tag.

In certain embodiments, the method includes, prior to transmitting the patient data, encoding the patient data in XML format. In certain embodiments, the method includes, prior to transmitting the patient data, applying a security algorithm to the patient data. In certain embodiments, verifying success of transmission includes presenting, on a display region of the computing device, at least a portion of the patient data for review and verification. In certain embodiments, verifying success of transmission includes at least one of: delivering an audible signal via the computing device; delivering a visual signal on a display of the computing device; and delivering a tactile or haptic signal via the computing device.

In certain embodiments, the method further includes providing at least a portion of the patient data for storage in a patient database system, wherein a remote computing device includes the patient database system. In certain embodiments, the method further includes providing the at least the portion of the patient data for storage in the patient database system, determining, by the processor, whether export criteria is met, wherein the export criteria includes at least one of a threshold number of patients and a time period.

In certain embodiments, the biological sample card includes a blood card for newborn screening; and the patient data includes patient birth date, patient birth time, patient birth weight, patient gender, patient ethnic code, and sample collection date. In certain embodiments, obtaining the patient data includes: presenting one or more data entry fields related to at least one of national and regional newborn screening information requirements; and receiving user input related to each data entry field of the one or more data entry fields. In certain embodiments, obtaining the patient data includes associating a new blood sample with stored patient data. In certain embodiments, the patient data further includes retest information.

In another aspect, the invention is directed to a system including: a processor; an antenna, wherein the antenna is configured for short range communication; and a non-transitory computer-readable medium storing instructions thereon wherein the instructions, when executed, cause the processor to: initiate communication with a transmission and storage device, wherein the transmission and storage device is configured for short range communication, and a biological sample card includes the transmission and storage device, obtain, via the antenna, patient data from the transmission and storage device, and evaluate the patient data to identify at least one laboratory test to perform on a biological sample, wherein the biological sample card includes the biological sample.

In certain embodiments, evaluating the patient data includes identifying at least one of an ethnicity, an age, a sex, an indication of premature birth, an indication of feeding type, a medication indication, and a steroid indication. In certain embodiments, the instructions, when executed, cause the processor to: identify, from the patient data, a patient identifier; and reference a patient database to identify stored patient data associated with the patient identifier. In certain embodiments, evaluating the patient data includes identifying, from the stored patient data, prior test results or prior attempted testing. In certain embodiments, the instructions, when executed, cause the processor to identify one or more discrepancies between the patient data and the stored patient data. In certain embodiments, the instructions, when executed, cause the processor to determine a punching pattern for punching the biological sample card, wherein the punching pattern is based in part upon one or more of the at least one laboratory test. In certain embodiments, the system further includes a punching apparatus, wherein the instructions, when executed, cause the processor to cause the punching apparatus to punch the biological sample card in the punching pattern.

In certain embodiments, the instructions, when executed, cause the processor to store, to a patient database, the patient information. In certain embodiments, the instructions, when executed, cause the processor to store, to the patient database, a status indicator, wherein the status indicator includes an indication regarding at least one of sample received, sample unusable, sample abnormal, sample testing ongoing, sample testing completed, and additional sample required. In certain embodiments, the instructions, when executed, cause the processor to store, to the patient database, one or more test results, wherein the one or more test results are associated, within the patient database, with the patient data. In certain embodiments, a separate computing device includes the patient database.

In another aspect, the invention is directed to a non-transitory computer-readable medium, wherein the computer-readable medium stores instructions that, when executed by a processor, cause the processor to: cause the presentation of a user interface for authentication of a user; receive a user identifier corresponding to the user; authenticate the user identifier; associate user biographic information with the user identifier; obtain patient information regarding a patient, wherein a biological sample is being collected from the patient onto a biological sample card including a transmission and storage device configured for short range communication; determine sample collection information, wherein the sample collection information includes at least a portion of the user biographic information and one or more of a date, timestamp, and location; receive a write request; initiate communication with a transmission and storage device; write the patient information and the sample information to the transmission and storage device; and verify successful transfer of the patient information and the biographic information to the transmission and storage device.

In certain embodiments, the user identifier includes biometric data. In certain embodiments, receiving the user identifier includes collecting fingerprint data corresponding to a fingerprint of the user, wherein the biometric data includes the fingerprint data. In certain embodiments, the instructions, when executed, further cause the processor to: collect, from a geolocation feature of a computing device, a current location, wherein the location is based on the current location. In certain embodiments, the instructions, when executed, further cause the processor to determine an address based upon the current location, wherein the location includes the address. In certain embodiments, the instructions, when executed, further cause the processor to collect fingerprint data corresponding to a fingerprint of the patient, wherein the patient information includes the fingerprint data. In certain embodiments, the instructions, when executed, further cause the processor to collect image data corresponding to a photograph of the patient, wherein the patient information includes the photograph. In certain embodiments, the instructions, when executed, further cause the processor to determine a current time, wherein the timestamp includes the current time. In certain embodiments, the user biographic information includes at least one of a name and a unique employee identifier. In certain embodiments, the instructions, when executed, further cause the processor to: obtain healthcare facility information, wherein the healthcare facility information includes two or more of a name of a health care professional, a telephone number, an address, a hospital name, a screening laboratory name, and a screening laboratory telephone number; and write the healthcare facility information to the transmission and storage device. In certain embodiments, the instructions, when executed, further cause the processor to provide inventory information regarding the biological sample to a computer system of a screening laboratory.

In another aspect, the invention is directed to a method including: scanning, by a scanner feature of a computing device, machine-readable indicia, wherein the machine-readable indicia is presented upon a biological sample card for stably storing a biological sample collected from a patient, and the machine-readable indicia includes a unique identifier; obtaining patient information regarding the patient; determining, by a processor of the computing device, sample collection data, wherein the sample collection data includes one or more of a date, timestamp, and location; providing, to a second computing device via a network, the patient data, the sample collection data, and the unique identifier, wherein the second computing device is configured to: store, associated with the unique identifier, the patient data and the sample collection data, and provide, to a third computing device, responsive to the third computing device providing the unique identifier, at least a portion of the patient data and the sample collection data.

In certain embodiments, the machine-readable indicia includes at least one of a barcode, two-dimensional barcode, three-dimensional barcode, QR code, and matrix barcode. In certain embodiments, the machine-readable indicia, when translated, includes card data related to at least one of a medical facility and a type of biological sample. In certain embodiments, the sample collection data includes the card data. In certain embodiments, a screening laboratory includes the second computing device.

In certain embodiments, the method further includes: obtaining healthcare facility information, wherein the healthcare facility information includes two or more of a name of a health care professional, a telephone number, an address, a hospital name, a screening laboratory name, and a screening laboratory telephone number, and the sample collection data includes the healthcare facility information. In certain embodiments, the computing device is a mobile computing device. In certain embodiments, the biological sample card includes a first portion and a second portion, wherein a perforation is positioned between the first portion and the second portion, the first portion includes the machine-readable indicia, and the second portion includes a copy of the machine-readable indicia.

In another aspect, the invention is directed to a method including: receiving, via a network, patient data, sample collection data, and a unique identifier, wherein the patient data includes demographic information regarding a patient, wherein a biological sample collected from a patient is stably stored on a biological sample card marked with the unique identifier, and the sample collection data includes one or more of a date, a timestamp, and location; storing, by a processor of a computing device, associated with the unique identifier, the patient data and sample collection data; receiving, via the network, a request including the unique identifier; and responsive to the request, providing, to a second computing device associated with the request, at least a portion of the patient data and the sample collection data.

In certain embodiments, the method further includes identifying, based upon a portion of the patient data, second sample collection data; and associating the second sample collection data with the sample collection data. In certain embodiments, providing the portion of the patient data and the sample collection data includes providing at least a portion of the second sample collection data. In certain embodiments, the method further includes providing, to a third computing device of a screening laboratory, via the network, inventory information regarding the biological sample. In certain embodiments, the sample collection data includes information regarding the screening laboratory.

In certain embodiments, the method further includes: receiving, from a third computing device of a screening laboratory, via the network, an alert regarding the biological sample; and responsive to receiving the alert, providing a message to one or more contacts regarding the alert, wherein the sample collection data includes the contacts. In certain embodiments, the alert includes at least one of an unusable sample, an availability of screening results, and an indication of abnormal results. In certain embodiments, providing the message includes one or more of an email, a text message, and a pre-recorded voice mail message. In certain embodiments, the contacts include one or more of a primary care physician, a hospital, and a midwife. In certain embodiments, the method further includes: receiving, from the third computing device, via the network, a set of screening results; and associating, by the processor, with the unique identifier, the screening results.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 illustrates an example of a biological sample card equipped with a biological sample card transmission and storage device for storing patient information;

FIG. 2 illustrates an example system for transferring data between a computing device and a biological sample card equipped with a biological sample card transmission and storage device;

FIG. 3 is a flow chart describing an example method for localized transfer of patient information to a biological sample card equipped with a biological sample card transmission and storage device;

FIG. 4 is a flow chart describing an example method for receipt of patient information and localized transfer of the patient information to hospital software;

FIG. 5 is a flow chart describing an example method for localized transfer of patient information to or from a biological sample card;

FIG. 6 is a flow chart describing an example method for exporting patient information to or from a remote application;

FIG. 7 is a flow chart describing an example method for transferring patient information from a biological sample card to a testing laboratory computing device;

FIG. 8 illustrates an example of a biological sample card that has received both valid and invalid biological samples;

FIGS. 9A through 9D illustrate a series of example graphical user interfaces for configuring an application for communication with a biological sample card containing a biological sample card transmission and storage device;

FIG. 10 illustrates an example of a cloud computing environment for sharing information related to biological sample testing;

FIG. 11 illustrates a flow chart describing an example method for collecting and transmitting information related to a biological sample;

FIG. 12 illustrates a flow chart describing an example method for receiving and transmitting information related to a biological sample;

FIG. 13 illustrates a flow chart describing an example method for receiving and transmitting information related to a biological sample;

FIG. 14 illustrates a chart describing an example method for communicating data regarding a biological sample to and from a data center;

FIG. 15 is a block diagram of an example network environment for communicating items with a biological sample card transmission and storage device; and

FIG. 16 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, a device including a short range communications device and support, such as radio-frequency identification (RFID) or near field communication (NFC) protocols, may be used to initiate communication with one or more biological sample cards.

The device, in some implementations, includes a portable computing device equipped with the short range communication device, such as, in some examples, a smart phone, handheld multimedia entertainment device, personal computer, personal digital assistant, tablet computer, notebook computer, or laptop computer. In some implementations, the short range communications device is an RFID reader and/or writer, a NFC reader and/or writer, or an RF, Bluetooth® or Wi-Fi™ transmitter and/or receiver.

The biological sample cards, in some implementations, include a machine-readable indicia. The machine-readable indicia may include a barcode, two-dimensional barcode, three-dimensional barcode, QR code, and/or matrix barcode. In some implementations, the machine-readable indicia is presented on a biological sample card for stably storing the biological sample collected from a patient. In some implementations the machine-readable indicia includes a unique identifier, data related to a medical facility, a type of biological sample, and/or sample collection data.

The biological sample cards, in some implementations, include a biological sample card transmission and storage device. Biological sample card transmission and storage devices may be passive mode communication devices (e.g., lacking a local power source) such as a passive radio transponder or a passive RFID or NFC tag. In some implementations, the biological sample card transmission and storage devices include semi-passive or active mode communication devices, such as a battery powered or battery backed up RFID tag, or a Wi-Fi™ or Bluetooth® transponder. In some examples, active mode communication devices include twisted antenna coils, laser embedded technology, or other micro active tag technology.

The biological sample card transmission and storage device, in some implementations, is built into the biological sample card. In some implementations, biological sample card transmission and storage devices are applied onto the packaging of the biological sample cards using adhesive material.

The biological sample card transmission and storage devices, in some implementations, include an RFID tag. An RFID tag, in some implementations, includes an integrated circuit for storing and processing information, modulating and demodulating a RF signal, and other specialized functions. In some implementations, the RFID tag is an NFC tag.

An RFID tag, in some implementations, includes an antenna for receiving and transmitting an RF signal. In some examples, an RFID tag may include an RF transmitter including a built in power supply (e.g., battery, etc.) to provide operating power. In other examples, an RFID tag may be “field powered”, obtaining operating power by rectifying an RF signal. In some implementations, the biological sample card transmission and storage devices include either passive RFID tags or semi-passive RFID tags which are provided with an alternating current (AC) signal.

In some implementations, the biological sample card transmission and storage devices include one or more features designed to enhance the security of transmission between the biological sample card transmission and storage device and the computing device. In some implementations, the biological sample card transmission and storage device may be embedded with one or more encryption features, e.g., an encryption mechanism, such that the computing device and the biological sample card transmission and storage device communicate through an encrypted transmission. In some implementations, the biological sample card transmission and storage device may be embedded with a unique identifier that may be included within transmission (e.g., in a packet header). A software application executing on the computing device, further to this example, may be designed to recognize a particular series or type of identification string. In some implementations, patient information may be encrypted by applying a security algorithm to the patient information, also known as patient data. In some implementations, the information stored on the biological sample card transmission and storage device is compressed.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

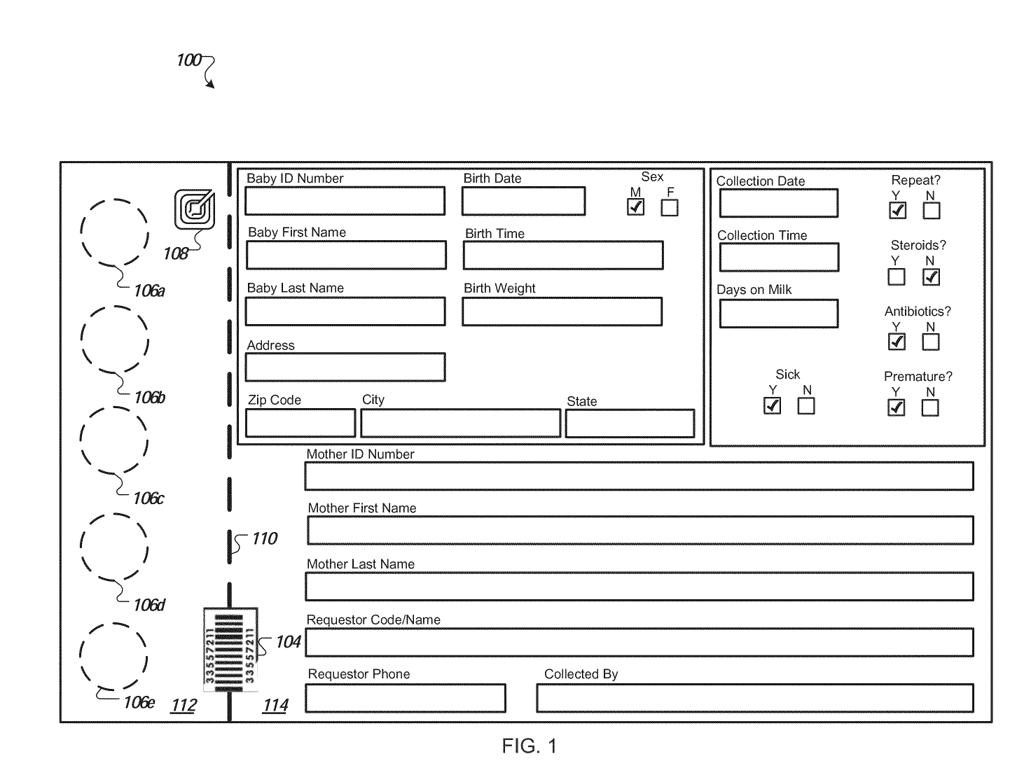

FIG. 1 illustrates an example of a biological sample card 100 used for newborn testing. Biological sample cards may be blood sample cards, blood spot cards, as well as, in some examples, biological sample cards for collecting cellular samples for genetics screening, blood/urine samples for drug use screening, or tissue samples for disease screening. In some implementations, biological sample cards are paper cards, plastic cards, cardboard cards, glass fiber cards, or they may be made of any other workable material. In certain alternative embodiments, rather than cards, biological samples are collected and contained in storage vials, serum sample containers, and/or other storage media, which have an attached or embedded RFID/NFC tag, for example.

In some implementations, the biological sample card 100 is used for newborn screening. Newborns are screened shortly after birth for a variety of conditions using blood testing. Typically, newborn screening requires blood samples to be taken from a newborn and sent to one of four hundred screening laboratories worldwide for processing. Blood samples may be collected by pricking a newborn baby's heel and placing the blood samples on a filter paper. The biological sample card 100 may include a portion 112 that is made of filter paper specifically designed to absorb the blood. Portion 112 may include collection regions 106 on the filter paper where the blood samples may be applied.

In some implementations, portion 114 of the biological sample card 100 is filled out with patient information, sample collection information, and/or a unique identifier using entry fields. The entry fields may be configured to receive text information. In some implementations, the text information is a non-electric rendering of at least a portion of the patient data. Patient information may include: patient identification number, patient first name, patient last name, patient address, patient birth date, patient birth time, patient birth weight, patient gender, patient ethnic code, repeat sample, the patient's parental information, or whether the patient has had a blood transfusion, received steroids, received antibiotics, whether the patient was born prematurely, whether the baby is sick, how the baby is feeding, whether the parents provided consent to testing, and/or whether the parents consent to using the specimen for research.

In some implementations, the patient information includes biometric data such as fingerprint data or data such as photos of the patient, pictures of the blood spots, or pictures of the biological sample card. Biometric data may include haptic data, image data, and/or tactile data.

In some implementations, the portion 114 of the biological sample card 100 is filled out with sample collection information. The sample collection information may include a date stamp, time stamp, information regarding the device used to collect information, information about the submitter of the information such as a name and/or unique employee identifier, and/or location information relating to when and where the biological sample was collected. In some implementations, the sample collection information includes information regarding the testing laboratory such as email information, phone number information, fax information, other contact information, and/or a user ID for logging into the data center, a web portal, or a software application to access relevant data for testing. In some implementations, the sample collection information includes contact information for the entity who submitted the biological sample for testing, such as a hospital or other medical facility. The contact information may include one or more phone numbers, email addresses, and/or fax numbers for contacting the relevant party or parties at the entity who submitted the biological sample for testing. The contact information may be for a primary care physician, hospital, and/or midwife.

In some implementations, the sample collection information includes healthcare facility information such as a name of a healthcare professional, a telephone number, an address, a hospital name, a testing laboratory name, and/or a testing laboratory telephone number.

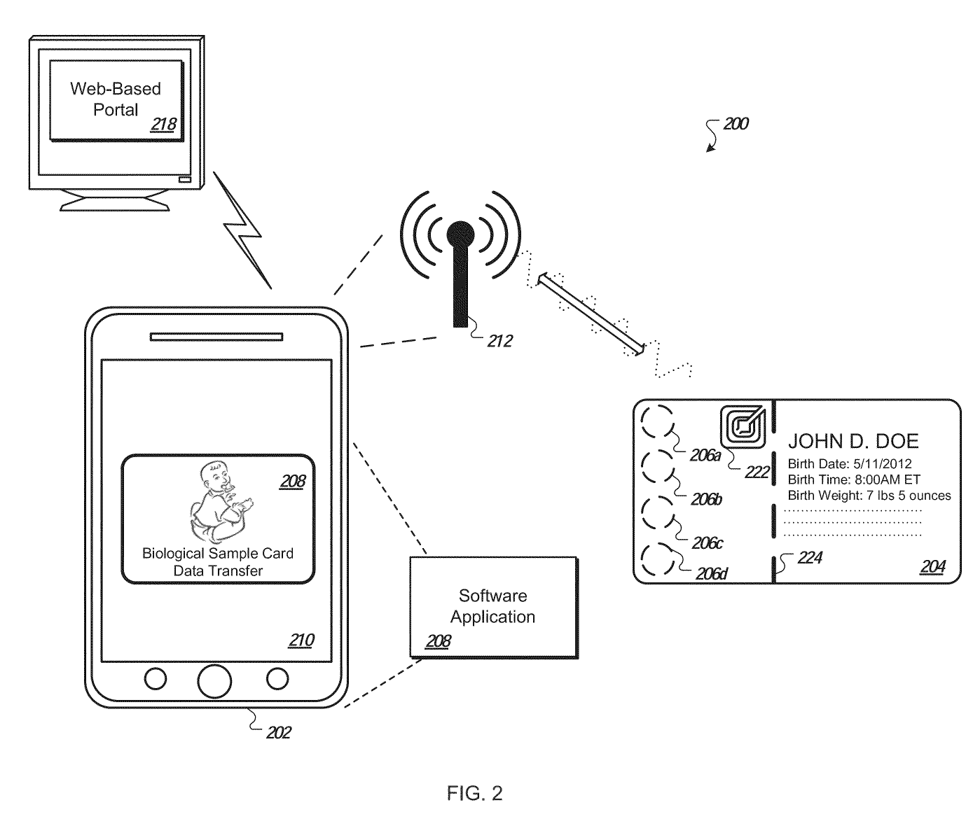

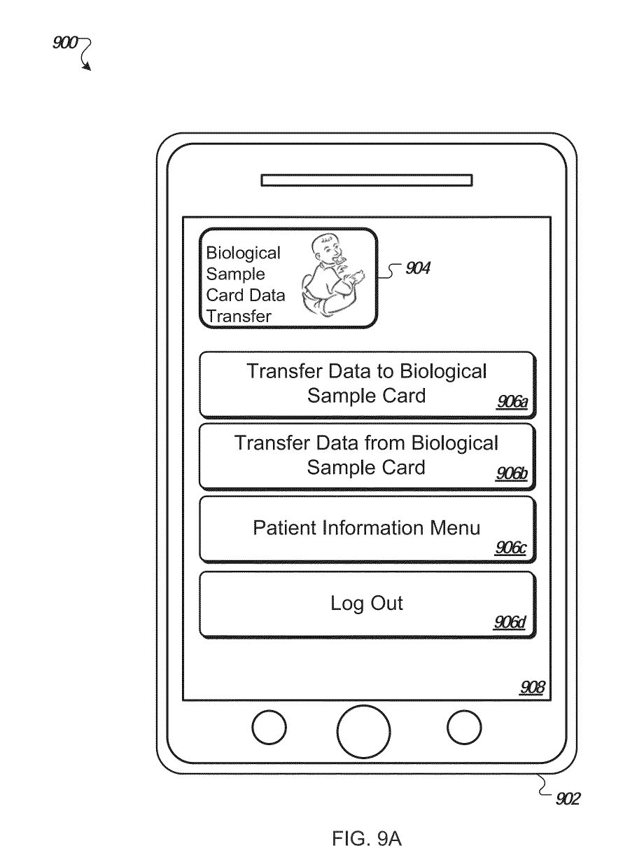

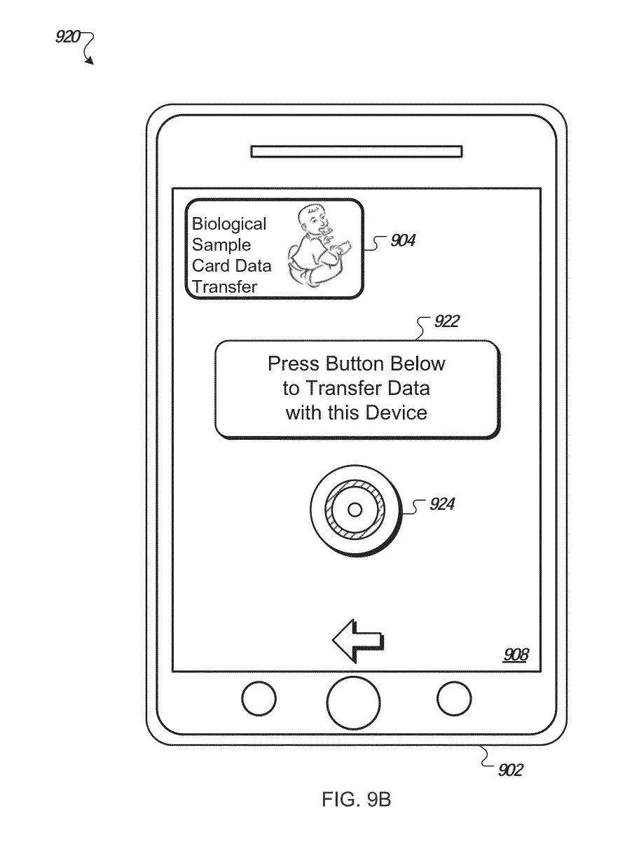

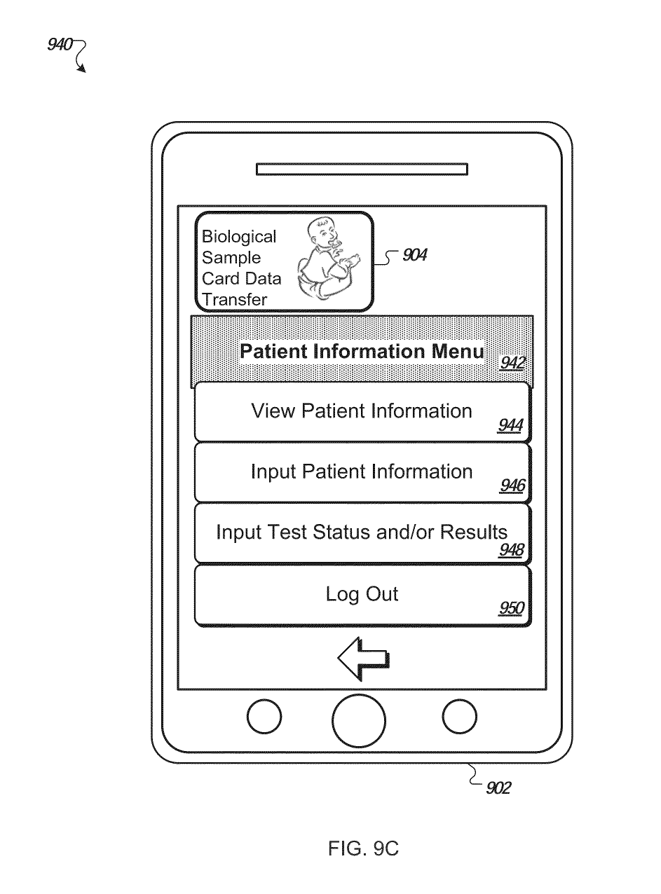

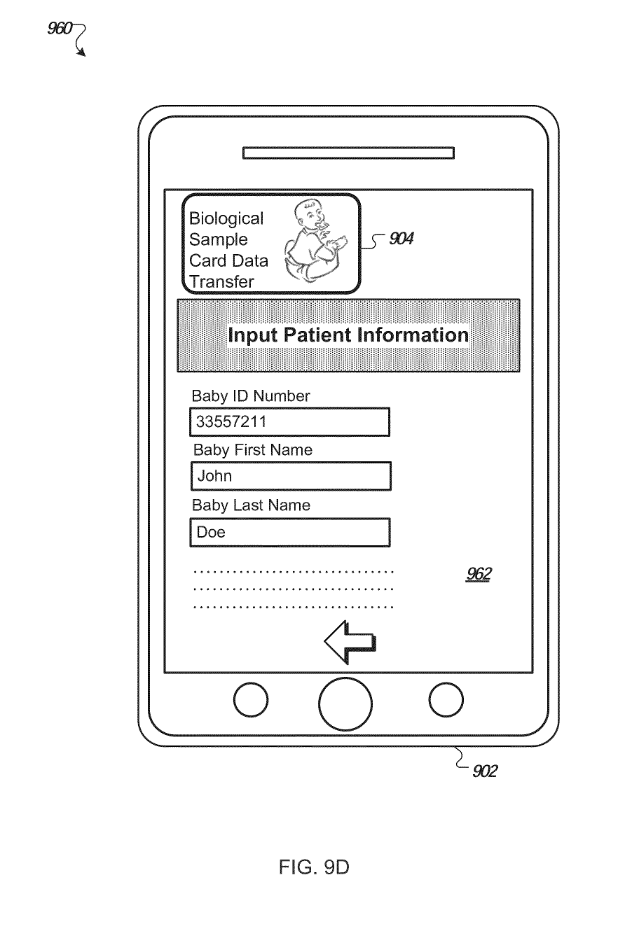

In some implementations, the patient information, sample collection information, and/or unique identifier are loaded into a software application using a scanner or optical character recognition tool. The patient information, sample collection information, and/or unique identifier may be loaded into a software application manually by a user who reads the information on the biological sample card and enters the information into the software program. In some implementations, patient information, sample collection information, and/or unique identifier are entered directly into a software application using a graphical user interface operating on a laptop, personal computer, smart phone, handheld multimedia entertainment device, personal digital assistant, or tablet computer as explained in reference to FIG. 9D. In such implementations, portion 114 of the biological sample card 100 may be omitted from the biological sample card 100 altogether. In some implementations, the sample collection data is generated by a computing device such as computing device 202 as shown in FIG. 2. In some implementations, at least a portion of the patient information, sample collection information, and/or unique identifier is received from a patient database system through a medical facility network. In some implementations, at least the patient information, sample collection information, and/or unique identifier is received by scanning a machine-readable indicia with a scanner of a computing device (e.g. wristband worn by the patient or a barcode located near the patient, on a medical chart, or hospital bed). The data captured from the machine-readable indicia may include the unique identifier. The unique identifier may be used to locate patient information associated with the unique identifier that is stored on the medical facility network. The software application may be connected to the medical facility network and may receive the patient information after providing the unique identifier to the medical facility network.

After the patient information, sample collection information, and/or unique identifier are loaded into the software program, the information may be transferred to the biological sample card 100 via a transmission and storage device. In some implementations, the transmission and storage device is a biological sample card transmission and storage device 108. In some implementations, the biological sample card transmission and storage device includes an antenna configured for short range communication and a computer-readable medium. The biological sample card transmission and storage device may be configured to receive patient information, sample collection information, and/or the unique identifier transmitted to the antenna, store the information in a computer-readable medium, and transmit the information via the antenna in response to a query signal. In some implementations, to transfer data to the biological sample card 100 via the biological sample card transmission and storage device 108, the biological sample card 100 is brought within close proximity of a short range communication device, or vice versa. In some implementations, the biological sample card 100 may be tapped against the short range communication device, or vice versa.

Biological sample card transmission and storage devices may be passive mode communication devices (e.g., lacking a local power source) such as a passive radio transponder or a passive RFID or NFC tag. In some implementations, the biological sample card transmission and storage devices include semi-passive or active mode communication devices, such as a battery powered or battery backed up RFID tag, or a Wi-Fi™ or Bluetooth® transponder. In some examples, active mode communication devices include twisted antenna coils, laser embedded technology, or other micro active tag technology.

In some implementations, the biological sample card transmission and storage device contains unique barcode information or a barcode identifier. The barcode information may be the barcode information associated with the machine-readable indicia 104. In some implementations, the biological sample card 100 does not contain a machine-readable indicia, however, the biological sample card transmission and storage device 108 may contain the unique identifier.

The biological sample card transmission and storage device 108 may be attached to the surface of the biological sample card 100 or built into the structure of the packaging of the biological sample card 100. In some implementations, the biological sample card transmission and storage device 108 is printed or applied to the biological sample card 100 during manufacturing. In some other implementations, the biological sample card transmission and storage device 108 is printed or applied to the biological sample card by the hospital. In some implementations, application of the biological sample card transmission and storage device 108 involves printing or applying a label using an adhesive. In a particular example, an adhesive biological sample card transmission and storage device 108 (e.g., a “sticker”) may be purchased by a user and applied to a biological sample card 100 for use in transferring data from the biological sample card 100 via the software application 108.

In some implementations, the biological sample card transmission and storage device 108 is located on portion 112 of the biological sample card 100. In some implementations, the biological sample card transmission and storage device 108 is built into the machine-readable indicia 104 (e.g., a barcode label, matrix barcode label, Quick Response (QR) code label, etc.) of biological sample card 100. The machine-readable indicia 104, in some implementations, is optional and may be provided as a back-up for identification of the biological sample card 100. In some implementations, machine-readable indicia 104 is embedded in the biological sample card transmission and storage device 108.

In some implementations, the biological sample card 100 is constructed using a three layer structure. The filter paper may be located between two layers, such as two slotted cardboard layers. In some implementations, the biological sample card transmission and storage device 108 is situated in the middle layer between the two layers. For example, the filter paper and the biological sample card transmission and storage device 108 may be situated between two pieces of slotted cardboard. This configuration may protect the biological sample card transmission and storage device 108 against mechanical damage and loosening. Additionally, the look, feel, and printings of the biological sample card 100 could be exactly the same as it has traditionally been.

Additionally, biological sample card 100 may include a perforated edge 110. In such cases, the biological sample card may be separated along the perforated edge 110 and only portion 112 of the biological sample card 100 is sent to the testing laboratory. The hospital may keep portion 114 of the biological sample card 100 or properly dispose of it. The hospital may be required to separate portions 112 and 114 of the biological sample card 100 before sending the information to the testing laboratory for privacy reasons. In some implementations, the entire biological sample card 100 is sent to the testing laboratory. In some implementations, as discussed above, the biological sample card 100 consists of portion 112 and does not include portion 114 and/or the perforation 110.

In some implementations, both portions 112 and 114 of the biological sample card include the machine-readable indicia 104. The perforation 110 may split the machine-readable indicia 104 in half or the machine-readable indicia 104 may be provided on each portion 112 and 114 of the biological sample card 100 such that when the biological sample card 100 is split along the perforation 110, each portion 112 and 114 contains a copy of the machine-readable indicia 104.

When the testing laboratory receives the biological sample card 100, the testing laboratory enters the patient information, sample collection information, and/or unique identifier into their computer system. In some implementations, the testing laboratory manually enters the patient information, sample collection information, and/or unique identifier into their computer based on the portion 114 of the biological sample card 100. In some implementations, the testing laboratory receives portions 112 and 114 of a biological sample card 100 separately. In such cases, the testing laboratory may manually enter the information on portion 114 along with the unique identifier of the machine-readable indicia 104 into their computer system. Before testing, the section of the machine-readable indicia 104 remaining on portion 112 may be scanned. The testing laboratory computer system can then instruct the user what tests need to be done based on the patient information and/or sample collection information associated with that unique identifier

In some implementations, the biological sample card 100 is tapped against a short range communication device to transfer the patient information, sample collection information, and/or unique identifier stored in biological sample card transmission and storage device 108 to the testing laboratory. In some implementations, the biological sample card 100 is brought within a specified distance of the short range communication device to transfer the information from the biological sample card 100 to the testing laboratory computer system. In these implementations, patient information, sample collection information, and/or unique identifier are inputted to the testing laboratory computer system without hand entering information that is read from a handwritten form.

In some implementations, multiple biological sample cards may be read at once. The testing laboratory may read all biological sample card samples in a given area. For example, the testing laboratory may bring all biological sample cards delivered on a day into a certain area and all of these biological sample cards may be read at the same time. After reading the biological sample cards, the testing laboratory may compare the biological sample cards received to an inventory list. In some implementations, the inventory list may be an electronic file or list that the testing laboratory receives from one or more hospitals or other entities submitting the biological sample cards. The electronic file or list may be shipped with the biological sample cards or sent via a network or accessed from a server. In some implementations, the testing laboratory manually enters a list into their computer system before the comparison can occur.

In some implementations, the testing laboratory may be equipped with intelligent shelving to locate individual specimens in a screening lab. Intelligent shelving may also be used for determining which samples have been received and comparing which samples were received with the inventory list. In some implementations, intelligent shelving is used to automatically provide status updates to the medical facility. For example, when a biological sample card is initially received and placed within a specified range of the intelligent shelf, the testing laboratory computer system may update the status of the biological sample card 100 to a “received” status. Similar methods may be used to identify when a sample is being tested, when the tests are complete, or to identify other steps completed by the testing laboratory during newborn screening.

After receiving the patient information, sample collection information, and/or unique identifier into their computer system, the testing laboratory determines whether certain tests are to be conducted based on the information on the biological sample card 100. These factors include, in some examples, demographic information, where the baby is born, whether the baby is sick, premature, using steroids, using antibiotics, and/or whether this is a repeat test. The testing laboratory also determines whether the blood sample is linked to previous test results (e.g. previous unusable or abnormal test results). In some implementations, the computer system of the testing laboratory will identify a patient from the patient information, sample collection information, and/or unique identifier and reference a patient database to identify stored information associated with the patient identified. Stored information includes prior test results or prior attempted testing data. In some implementations, the computer system of the testing laboratory identifies one or more discrepancies between the patient information and the stored patient information.

Once the testing laboratory determines which tests to conduct, a biological sample punching device may be used to extract the collection regions 106 from the biological sample card 100 and process the samples for testing. Biological sample punching devices enable screening laboratories to processor multiple biological sample cards simultaneously. Additionally, biological sample punching devices are capable of punching samples differently depending on the quality of the sample, the tests being performed, and the patient information and/or sample collection information of a specific biological sample. The computer system can read the biological sample card transmission and storage device 108, in some implementations, and instruct the biological sample punching device directly how to punch the biological sample card 100 based on patient information and/or sample collection information stored in the biological sample card transmission and storage device 108. The biological sample punching device may determine a punching pattern based in part on, in some implementations, the quality of the sample, the tests being performed, and the patient information of the specific blood sample. In some implementations, the blood samples are extracted from portion 112 manually and the computer system may provide instructions to the lab technician regarding how to punch the biological sample card 100.

In implementations where a biological sample punching device or a biological testing instrument is used, a short range communication device may be located next to the biological sample punching device or the biological testing instrument. In some implementations, a short range communication device is integrated, either internally or externally, with the biological sample punching device and/or biological testing instrument. Locating a short range communication device near the biological sample punching device and/or biological testing instrument may reduce any error that occurs between reading the biological sample card transmission and storage device 108 and punching the biological sample card 100. In some implementations, there may be multiple short range communication devices in the testing laboratory.

After the filter paper is punched by the biological sample punching device or manually separated by a lab technician, the testing laboratory may begin conducting tests on the blood sample. As described in reference to FIG. 2, the testing laboratory may input the test status and/or results into a software application such as Specimen Gate® Screening Center™ by PerkinElmer of Waltham, Mass. A hospital may be provided access to this information so that hospital staff can monitor the status of tests and/or receive test results quickly and efficiently.

FIG. 2 illustrates an example system 200 for localized data transfer with biological sample cards. In some implementations, the system 200 for transferring data to and from a biological sample card 204 includes a computing device 202 and the biological sample card 204 with a biological sample card transmission and storage device 222. The computing device 202, as illustrated, may be an electronic device equipped with a short range communication device such as, in some examples, a laptop, personal computer, smart phone, handheld multimedia entertainment device, personal digital assistant, or tablet computer. In some implementations, the short range communications device is an RFID reader and/or writer, a NFC reader and/or writer, RF, Bluetooth® or Wi-Fi™ transmitter and/or receiver. In some implementations, device 202 is a biological sample punching device or in communication with the biological sample punching device.

The computing device 202, in some implementations, executes a software application 208 (e.g., “Biological sample card Data Transfer”, as illustrated in a display 210 of the computing device 202). In some implementations, the software may cause the presentation of a user interface for authentication of a user. The user may input a user identifier corresponding to the user that can be authenticated by the software to confirm the identity of the user. After authentication, the software may associate user biographical information with the user identifier. In some implementations, the user identifier is a username and password, voiceprint, fingerprint, and/or scan of an employee badge. In some implementations, biographical information is a name, contact information such as email, phone number, address, employee number, supervisor, and/or medical facility.

As discussed in reference to FIGS. 9A through 9D below, the software application 208 may receive patient information, sample collection information, and/or unique identifier. The patient information may be stored locally on computing device 202 or on a network. Patient information may include: patient identification number, patient first name, patient last name, patient address, patient birth date, patient birth time, patient birth weight, patient gender, patient ethnic code, sample collection date, sample collection time, repeat sample, the patient's parental information, or whether the patient has had a blood transfusion, received steroids, received antibiotics, whether the patient was born prematurely, whether the baby is sick, how the baby is feeding, the requestor code/name, requestor phone, the sample collector name, whether the parents provided consent to testing, and/or whether the parents consent to using the specimen for research.

Sample collection information includes at least a portion of the user biographical information, a date stamp, time stamp, type of sample, whether the sample is for an original test or a retest, the purpose of the sample, information regarding the device used to collect information, information about the submitter of patient information such as a name and/or unique employee identifier, and/or location information relating to when and where the biological sample was collected. In some implementations, the sample collection information includes information regarding the testing laboratory such as email information, phone number information, fax information, and/or other contact information. In some implementations, the sample collection information includes contact information for the entity who submitted the biological sample for testing, such as a hospital or other medical facility. The contact information may include one or more phone numbers, email addresses, and/or fax numbers for contacting the relevant party or parties at the entity who submitted the biological sample for testing. The contact information may be for a primary care physician, hospital, and/or midwife.

In some implementations, the sample collection information includes healthcare facility information such as a name of a healthcare professional, a telephone number, an address, a hospital name, a testing laboratory name, and/or a testing laboratory telephone number.

After receiving patient information, sample collection information, and/or unique identifier, the software may transfer the data to the biological sample card 204 via antenna 212 of a short range communication device. The software application 208, in some implementations, controls an antenna 212 (e.g., an internal or external antenna for operation in a short range communication frequency band) for communication with the biological sample card transmission and storage device 222, preferably within a near field range. In some implementations, the antenna 212 of the short range communication device is placed near the biological sample punching device of the testing laboratory as discussed above in reference to FIG. 1.

In some implementations, to transfer data to the biological sample card 204 via the biological sample card transmission and storage device 222, the computing device 202 first establishes a connection with the biological sample card transmission and storage device 222. To establish the connection and transfer data with the biological sample card transmission and storage device 222, in some implementations, the computing device 202 is brought within close proximity of the biological sample card transmission and storage device 222, or vice versa. For example, in the circumstance of a NFC tag, the computing device 202 or biological sample card 204 may be brought within a range of about ten centimeters or fewer for connection purposes. In some implementations, the software application 208 and/or the computing device 202 provides an indication regarding successful data transfer (e.g., audible tone, graphic message, visual cue, blinking lights, tactile feedback, or haptic feedback, etc.).

In some implementations, after successful data transfer, the software application clears the patient information, sample collection information, and/or unique identifier and displays the data entry screen and waits for further user action.

In some implementations, the biological sample card 204 is preloaded with the unique identifier. In some implementations, the biological sample card 204 may be loaded with the unique identifier when the patient information is transferred onto the biological sample card 204.

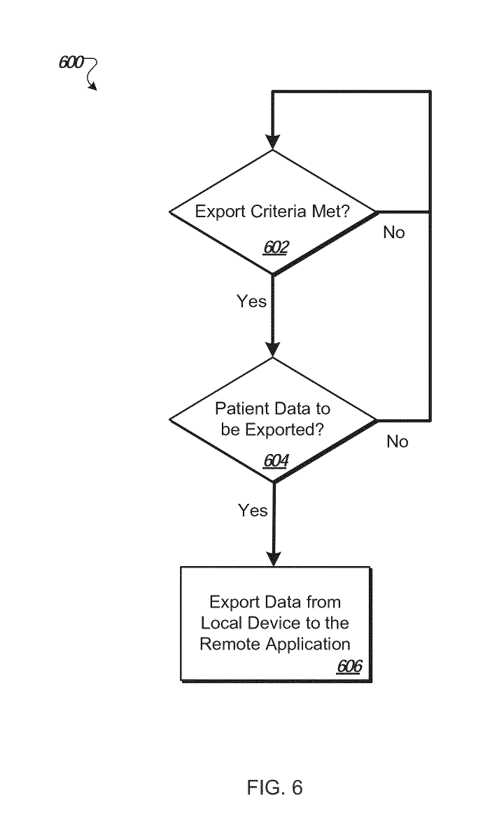

In some implementations, the software application 208 includes an export feature for transferring patient information, sample collection information, and/or the unique identifier stored on the biological sample card 204 to another software application located locally or on a network. Examples of such a software program include Specimen Gate®, eReports™, or Labworks™ Laboratory Information Management System, all by PerkinElmer of Waltham, Mass. For example, patient information sent to another software application, in some implementations, can then be accessed from a number of locations. Additionally, the status of the biological sample card 204 may be monitored so that the medical facility or user of the other software application can receive status updates from a testing laboratory that receives the biological sample card and associated biological samples. Status updates may include whether the sample was received, whether the sample is usable, whether the testing is ongoing, whether the testing is complete, whether additional samples are required, whether the sample is abnormal, what tests are being performed, the test results, and follow-up activities related to the patient's diagnosis. The status information may be stored in a patient database that is located locally, on a network, server, or remote storage device. An example procedure for transferring patient information, sample collection information, and/or the unique identifier to another software application is described in relation to FIG. 6. In some implementations, the information is not transferred to another software application. A transfer to the medical facility computer system may involve a secure web connection or a web service. Alternatively or additionally, it could involve a hard wire data transfer.

In some implementations, the software application 208 facilitates a connection to a web-based portal 218 for accessing, exporting, or importing information regarding biological sample cards. For example, the web-based portal 218 may allow a user to configure or manage the information associated with one or more biological sample cards. In some implementations, the web-based portal 218 includes patient and status information regarding the biological sample card 204.

In some implementations, the biological sample card 204 includes regions 206 on filter paper where the biological samples may be applied.

In some implementations, the biological sample card 204 may include a perforated edge 224. The perforated edge 224 may provide one or more utilities such as those described in relation to perforation 110 of FIG. 1 above.

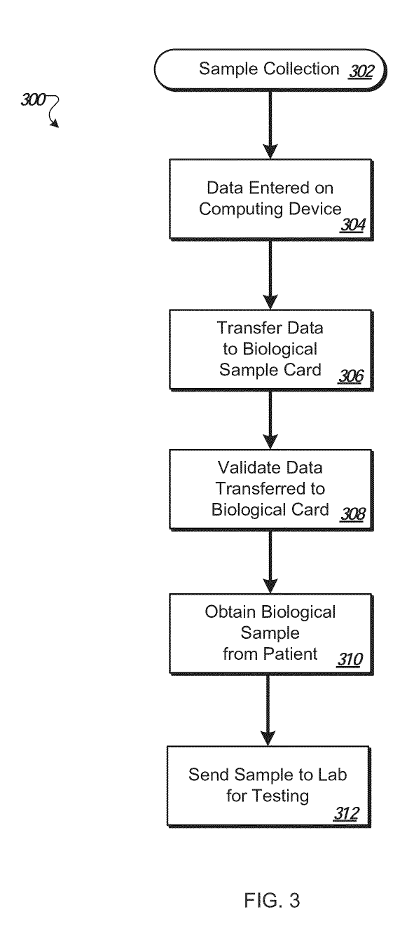

FIG. 3 illustrates a flow chart describing an example method 300 for localized transfer of data to a biological sample card. The method 300, for example, may be performed by the processor of a computing device such as computing device 202 described in relation to FIG. 2. For example, one or more steps of method 300 may be performed by software application 208.

The method 300 begins, in some implementations, when a sample is going to be collected from a patient (302). When a biological sample is going to be collected, information is entered into a computing device (304). The computing device may be an electronic device equipped with an short range communication device such as, in some examples, a personal computer, laptop, smart phone, handheld multimedia entertainment device, personal digital assistant, or tablet computer.

In some implementations, a portion of the data may be captured by scanning an item associated with the patient, such as a barcode or RFID tag incorporated in a wristband worn by the patient or a tag located near the patient (e.g. a tag on a medical chart or hospital bed). The data may be captured by a computing device using a barcode scanner or short range communication device. In some implementations, information is derived via a query of a medical facility record system to obtain a portion of the patient record.

For example, if blood is being collected by a midwife, the midwife may use a portable electronic device like a tablet computer or smart phone running an appropriate software application. The midwife would begin by entering the patient information, sample collection information, and/or unique identifier into the software application. It should be appreciated that the midwife could be performing the sample collection (302) in a hospital or medical care facility, in a patient's home, or in any other location. Additionally, sample collection (302) could be performed by any doctor, nurse, or other medical personnel.

In some implementations, once data is entered onto a computing device (304), the data may be transferred onto a biological sample card (306). In some implementations, data is transferred when a user brings the biological sample card within a threshold distance of a short range communication device coupled to the computing device. In some implementations, the data is transferred when the biological sample card is tapped against the computing device equipped with the short range communication device. The data includes at least a portion of the data entered onto the computing device during step (304). In some implementations, the biological sample card is brought within a specified range of a short range communication device.

Transferring data onto the biological sample card may begin, in some implementations, with receiving a request to communicate with a biological sample card transmission and storage device located on or in the biological sample card. In some implementations, a user submits a request to the computing device to open a communication channel with the biological sample card transmission and storage device. The user may request opening the communication channel with the biological sample card transmission and storage device using a graphical user interface of a software application executing upon the computing device.

In some implementations, the data is stored on the biological sample card in extensible markup language (XML), comma separated variable format, proprietary format, data format, or text format.

In some implementations, after transferring the data to the biological sample card, a validation procedure is performed to verify the transfer occurred properly (308). The validation procedure verifies that the information was copied properly. For example, if the operation is a write operation, the processor can read at least a portion of the information from the biological sample card and compare this information with the information it wrote to the biological sample card. In some implementations, the validation procedure ensures that the data transferred to the biological sample card complies with the business rules specified by a testing laboratory or other party.

In some implementations, after transferring the data and/or validating the data, a biological sample is obtained from the patient (310). Biological samples taken from the patient are applied to the biological sample card storing the patient's information. After this process is complete, the biological sample card and associated biological samples may be sent to the lab for testing (312).

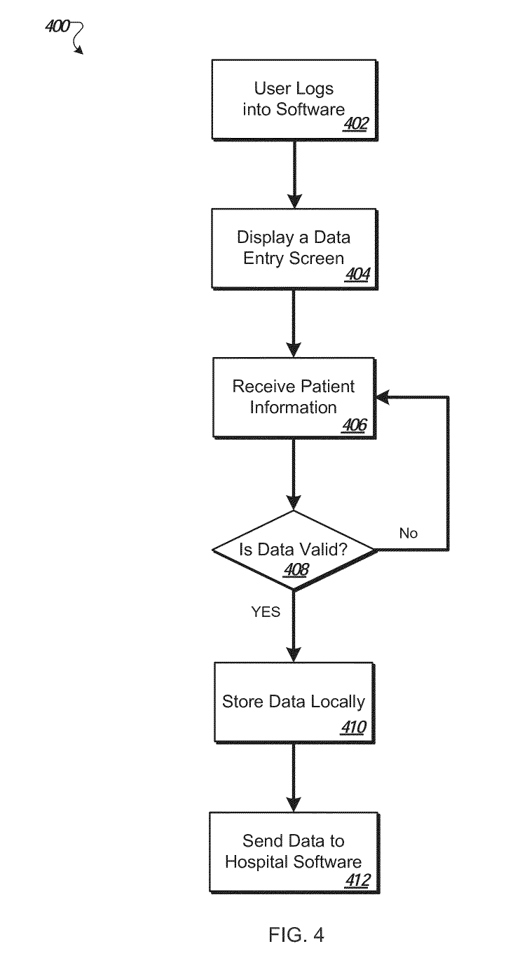

FIG. 4 illustrates a flow chart describing an example method 400 for localized transfer of data to a biological sample card. The method 400, for example, may be performed by the processor of a computing device such as computing device 202 described in relation to FIG. 2. For example, one or more steps of method 400 may be performed by software application 208.

In some implementations, a user logs into a software application (402) to begin method 400. The software application may include security measure options such as requiring the user to enter a user name and password or enter a secure identification code. After a user logs into the software, in some implementations, a data entry screen is displayed (404). The data entry screen may be customer specific. Different hospitals and/or countries utilize biological sample cards with different information. Therefore, the data entry screen may be customized to display the appropriate information input regions. Using the data entry screen, patient information, sample collection information, and/or unique identifier may be entered into the computing device running the software application (406). In some implementations, the processor receives data entered during the check-in procedure at a hospital. For example, based on partial data entry (e.g. date of birth and last name), one or more fields auto-populate. This eliminates the need to reenter the data.

In some implementations, at least a portion of the data may be captured by scanning an item associated with the patient, such as a barcode or an RFID tag that is incorporated in a wristband worn by the patient or a tag located near the patient (e.g. a tag on a medical chart or hospital bed). The data may be captured by a computing device using a bar scanner or short range communication device.

After the processor receives patient information, sample collection information, and/or unique identifier, the processor determines whether the data is valid (408). The processor verifies that the data entered conforms with established business rules. For example, the patient information may be validated with regard to hospital records such as validating the patient's birthdate or other patient information based on the hospital records. If the validation process fails, the system may prompt the user to correct the patient information. This process could involve determining whether required patient information was inputted into the computing device during step (406). If the data is not valid, the processor returns to step (406). If the data is valid, the processor may store the data locally (410).

In some implementations, the patient information, sample collection information, and/or unique identifier are stored in a local memory location accessible to the computing device (410). The memory location, in some implementations, includes a network-accessible storage area. In this manner, for example, the computing device may be damaged, replaced, and/or power cycled without losing the stored information. In some implementations, a portion of the information is shared with a separate device. For example, through a web portal or through a network-accessible storage location, a separate device such as a user personal computer may access the stored information. In some implementations, the data is not stored locally. The data may be stored temporarily and transferred on a batch or periodic schedule. In some implementations, if the network is not available, a queue will be created and the data will be stored in the queue until the network is available. When the network returns, the data in the queue can be uploaded one by one based on the order in the queue or in a batch.

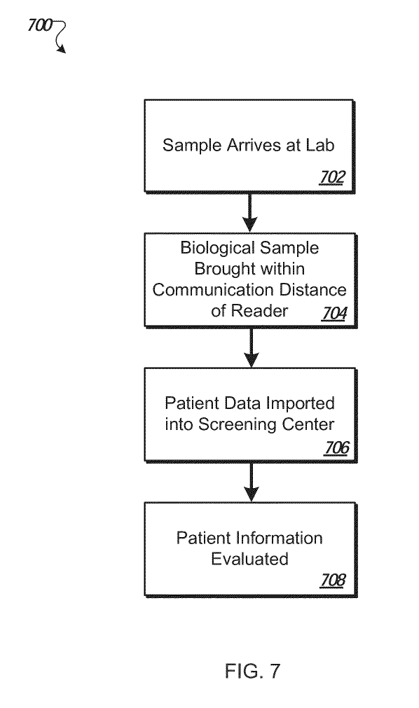

In some implementations, the processor sends the patient information, sample collection information, and/or unique identifier to another software application located locally or on a network. Examples of such a software program include Specimen Gate®, eReports, or Labworks™ Laboratory Information Management System, all by PerkinElmer of Waltham, Mass. Patient information, sample collection information, and/or unique identifier sent to the other software application can then be accessed from a number of locations. Additionally, the status of the biological sample card may be monitored so that the hospital or user of the other software application can receive status updates from a testing laboratory that receives the biological sample card and associated biological samples. Status updates can include whether the sample was received, whether the sample is abnormal, what tests are being performed, and the tests results. An example procedure for transferring patient information, sample collection information, and/or unique identifier to another software application is described in relation to FIG. 7. In some implementations, the information is not transferred to another software application.

In some implementations, if the patient information, sample collection information, and/or unique identifier are not stored locally and/or exported to another software application, the processor may instruct the user to transfer the patient information, sample collection information, and/or unique identifier to the biological sample card (412). The process of transferring patient information to the biological sample card is described above in relation to FIG. 3. In some implementations, the processor may instruct the user to transfer the information to the biological sample card after the information is stored locally and/or exported to another software application. In some implementations, the patient information, sample collection information, and/or unique identifier may be transferred to the biological sample card before or after the information is stored locally or transferred to another software application.

In some implementations, if the computing device enters a sleep mode or the application isn't used for a configurable period of time, the user may be required to log in again. If the configurable period of time has not elapsed, the processor may display the data entry screen and allow the user to enter another specimen after the data from the earlier specimen is validated.

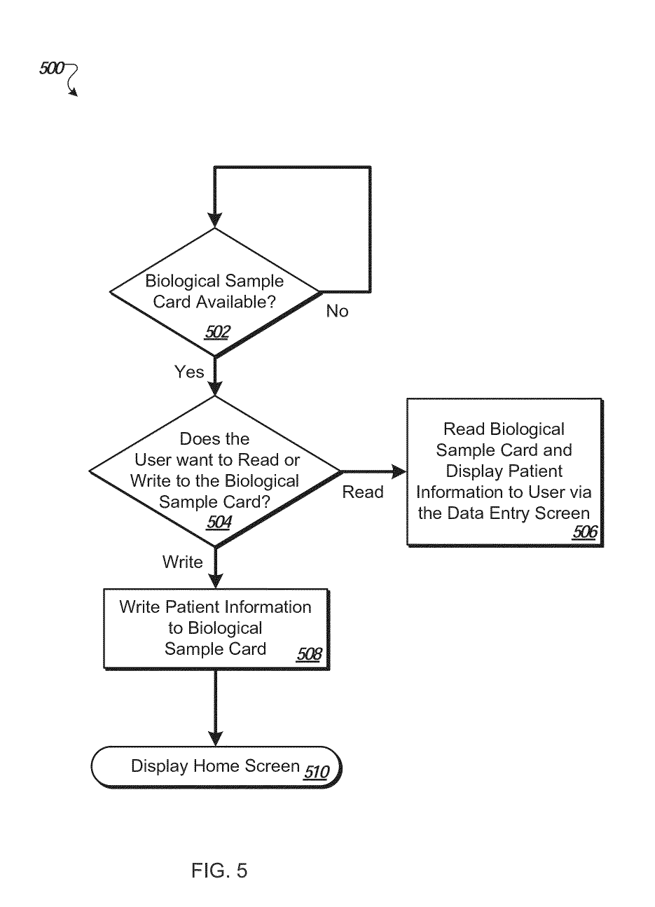

FIG. 5 illustrates a flow chart describing an example method 500 for localized transfer of data to/from a biological sample card. The method 500, for example, may be performed by the processor of a computing device such as computing device 202 described in relation to FIG. 2. For example, one or more steps of method 500 may be performed by software application 208.

In some implementations, once data is received, the data is transferred onto the biological sample card. In some implementations, the data is transferred when the biological sample card is tapped against the computing device equipped with a short range communication device. The data may include the data received by the computing device about a patient. In some implementations, the computing device receives patient information, sample collection information, and/or unique identifier by scanning an item associated with the patient, such as a barcode or RFID tag incorporated in a wristband worn by the patient or a tag located near the patient (e.g. a tag on a medical chart or hospital bed).

The method of transferring data onto the biological sample card may begin, in some implementations, when the processor detects the availability of a transmission and storage device for communication (502). In some implementations, the user brings the biological sample card within a threshold distance of a computing device. In some implementations, the user requests pairing of the biological sample card with the computing device through a graphical user interface of a software application executing upon the computing device. The computing device may use any type of short range communication technique for communicating with the biological sample card transmission and storage device such as, in some examples, RFID or other NFC protocols.

In some implementations, once the biological sample card is detected, the processor prompts a user via a graphical user interface whether they want to read or write to the biological sample card (504). If the user selects a read operation, the processor will read the biological sample card and optionally display patient information, sample collection information, and/or unique identifier to the user via a display screen (506). In some implementations, the display screen is the data entry screen and/or a confirmation screen. In some implementations, the processor secures or blocks sensitive patient information such as the mother's social security number and displays only enough patient information to verify that the patient information is for the correct patient. If the user selects the write option, the processor moves to step (508).

In some implementations, the processor may automatically determine whether the user wants to read or write based on a number of factors including the location of the data transfer, such as whether it is at a hospital or a lab, and whether the biological sample card has data already loaded. If the biological sample card has no data loaded, the processor could automatically determine that this is a write operation. If the biological sample card is already loaded with data, the processor could automatically determine that this is a read operation. The software may be configured to only read or only write depending on the use, such as whether the software is being used by a hospital or testing laboratory.

If the operation is a write operation, the processor transfers the information from a computing device to the biological sample card (508). After writing the information, the processor displays the home screen (510).

In some implementations, after writing the information, the processor performs a validation procedure. The validation procedure verifies that the information was written properly. For example, if the operation is a write operation, the processor can read at least a portion of the information from the card and compare this information with the information it wrote to the card.

FIG. 6 illustrates a flow chart describing an example method 600 for export of data to and from a remote application. The method 600, for example, may be performed by the processor of a computing device such as computing device 202 described in relation to FIG. 2. For example, one or more steps of method 600 may be performed by software application 208.

In some implementations, the processor sends the patient information, sample collection information, and/or unique identifier to a remote software application located locally or on a network. Examples of such a software program include Specimen Gate®, eReports, or Labworks™ Laboratory Information Management System, all by PerkinElmer of Waltham, Mass. In some implementations, patient information, sample collection information, and/or unique identifier are accessible by another software application from a number of locations. Additionally, the status of the biological sample card may be monitored so that the medical facility or user of another software application can receive status updates from a testing laboratory that receives the biological sample card and associated biological samples. Status updates can include whether the sample was received, whether the sample is abnormal, what tests are being performed, and the tests results. In some implementations, a hospital monitors when a sample is collected.

In some implementations, the process of exporting data to the remote application requires a request by a user. In some implementations, this process operates autonomously and no user input is required to start this process.

In some implementations, the processor determines whether a set of export criteria are met (602). The criteria may be configurable and can include, but is not limited to, an expected period of time or a certain amount of data or patients. For example, the processor may export data to the remote application every 24 hours, at the end of the day, or after receiving data for a certain number of patients, such as ten patients.

In some implementations, once the triggering event has been satisfied, the processor verifies that there is patient data to be exported (604). For example, if the criteria is set to export data every 24 hours, the processor verifies that there is data to export (604). If there is no data, no export will occur. If data exists, the processor exports data from the local computing device to the remote application (606). The export operations may be specific to the applications involved. For instance, a transfer to eReports™, by PerkinElmer of Waltham, Mass., may involve a secure web connection and a web service. Other possible scenarios would involve transfers to Labworks™ Laboratory Information Management System, by PerkinElmer of Waltham, Mass. Using the remote application, the status of the biological sample card may be monitored so that the hospital or user of the other software application can receive status updates from a testing laboratory that receives the biological sample card and associated biological samples. Status updates can include whether the sample was received, whether the sample is abnormal, what tests are being performed, and the tests results. In some implementations, the transfer or export of data involves a hard wire data transfer/export or a wireless transfer/export.

FIG. 7 illustrates a flow chart describing an example method 700 for transferring of data to a testing laboratory. The method 700, for example, may be performed by the processor of a computing device such as computing device 202 described in relation to FIG. 2. For example, one or more steps of method 700 may be performed by software application 208.

In some implementations, after data, such as patient information, is loaded onto the biological sample card and the biological sample is taken, the sample and biological sample card are sent to a testing laboratory. The testing laboratory could be a biological sample testing lab. After the biological sample card and biological sample arrive at the testing laboratory (702), the lab transfers the data on the biological sample card to a computing device. In some implementations, before transferring the data on the card to the computing device, the envelopes are opened and sorted according to various criteria such as the type (initial or repeat) and the quality of the sample.

In some implementations, to transfer data from the biological sample card to the computing device, the biological sample card is brought within communication distance of the short range communication device (704). For example, bringing a biological sample card within communication distance of the short range communication device may involve a tap, bringing the biological sample card near the short range communication device, or setting the biological sample card on a platform from which the biological sample card can be read. The short range communication device may be a standalone reader or may be built into the computing device or biological sample punching device. The short range communication device may be located at the computing device or at the biological sample punching device, or at both locations. The computing device could be a smart phone, personal computer, personal digital assistant, tablet computer, notebook computer, or laptop computer.

After the biological sample card is tapped against or placed within close proximity of the short range communication device, the data containing the patient information, sample collection information, and/or unique identifier is imported into the testing laboratory computer system (706). At this point, in some implementations, the data may be imported into a testing laboratory software program such as Specimen Gate® software, by PerkinElmer of Waltham, Mass. The import may occur automatically or after receiving instruction from a user to begin the import. The import may be a local import, an import from a server, or form a local area network.

In some implementations, the patient data is evaluated (708). The evaluation may include a comparison of the patient information received from the biological sample card and all other previously tested samples to see if the incoming specimen is from an existing patient and, if so, whether or not the previous specimen was abnormal or unusable. If the specimen is from an existing patient, the processor may obtain data from a server or other storage device to make this determination. In some implementations, the name of the patient may have changed. In such instances, patient information besides the last name, such as parental information, birth date, etc., may be compared to patient information from the server or other storage device.

In some implementations, the type of tests to run against the biological sample are determined automatically based on the data received from the biological sample card. The processor can make this determination based on demographic information such as state, ethnicity, and whether it is a first test or follow-up test.

An application providing instructions to the short range communication device, for example, can review data obtained from the biological sample card and provide instruction on how to punch the biological sample card based on patient information and/or sample collection information stored in the biological sample card transmission and storage device on the biological sample card. In some implementations, the application instructs a user via a display or submits instructions to the biological sample punching device. Biological sample cards may be punched differently depending on the patient information and/or sample collection information. Locating the short range communication device near the biological sample punching device may reduce any error that occurs between reading the biological sample card transmission and storage device in the biological sample card and punching the card. When the biological sample is loaded at the biological sample punching device, the processor already knows how to punch the biological sample based on the determination the processor made regarding the types of tests that need to be run.

After the information is transferred, the testing laboratory can update a status of the sample testing to a status identifying that the sample has been received. The status may also include whether the sample is abnormal, where the sample is unusable, what tests are being performed, whether the test was satisfactory, and the tests results. In some implementations, the status information may be loaded into the computing device and associated with the relevant patient information and/or sample collection information that was transferred from the biological sample card. Moreover, in some implementations, the sender of the biological sample card and biological sample can receive or view the status information remotely. In some implementations, if the sample was unsatisfactory, the sender may be informed via the status information. The sample may be unsatisfactory, in some examples, if the volume of the biological sample is inadequate or the biological sample comes in contact with certain substances, such as a lotion or powder.

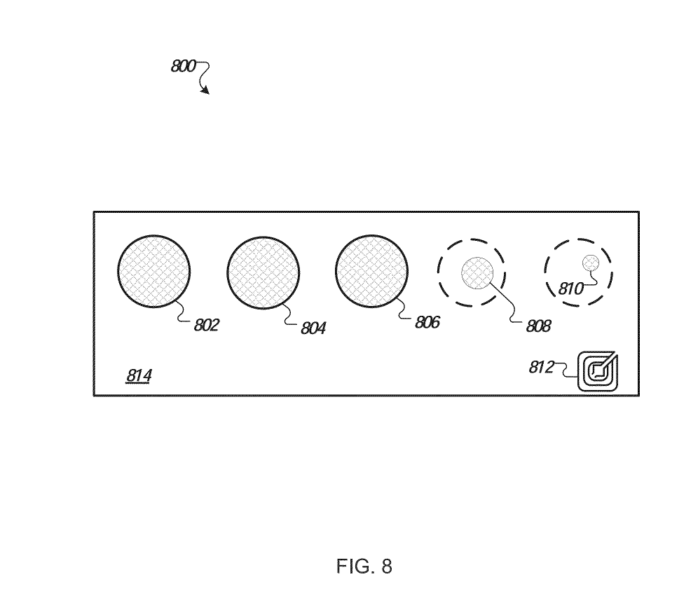

FIG. 8 illustrates a portion 814 of a biological sample card that includes both valid and invalid blood samples. In some implementations, the portion 814 includes a biological sample card transmission and storage device 812.

Sometimes during blood collection, blood volumes vary between blood samples. This problem occurs, for example, when the filter paper of portion 814 is removed too quickly or if the filter paper comes in contact, either before or after collection, with ungloved hands or substances such as a lotion or powder. As shown in FIG. 8, blood spot samples 802, 804, and 806 are large and therefore considered valid. However, blood spot samples 808 and 810 are small and unusable. In the case of unusual blood spot samples, additional blood spot samples may need to be taken using a new biological sample card. In some implementations, the medical facility may monitor and receive status updates from the testing laboratory. Additionally, errors related to manually entering patient information from a handwritten card may be eliminated and thus reduce delays associated with manual labor. In this specific example, in some implementations, the testing laboratory may notify the hospital via their software system. Moreover, the testing laboratory is able to process biological sample cards faster and reduce the inefficiencies associated with current technology.

FIGS. 9A through 9D illustrate various implementations of user interfaces for configuring and using a software application for localized data transfer. As shown in FIG. 9A, in some implementations, a first screen shot 900 of a software application executing on a computing device 902 includes an application logo 904 and a series of main menu controls 906 within a display region 908. A user installs the software application, in some implementations, to transfer data to and/or from a biological sample card within a specified range of the computing device 902. In some implementations, the software application correlates patient information and/or sample collection information with a unique identifier of a machine-readable indicia scanned by computing device 902 from the biological sample card. In some implementations, a unique identifier may be assigned and associated with patient information and/or sample collection information by the user of the software, by the software program automatically, or by a data center after the patient information and/or sample collection information is uploaded to the data center. As described below, the controls provided to a user may vary based on whether the software is being used by hospital staff, doctor's office staff, midwives, or testing laboratory.

A first control 906a labeled “Transfer Data To Biological Sample Card” and a second control 906b labeled “Transfer Data From Biological Sample Card”, in some implementations, provide a user, upon selection, with the ability to transfer data between the biological sample card equipped with a biological sample card transmission and storage device and the computing device 902 equipped with a short range communication device. In some implementations, to transfer data between a biological sample card and the computing device 902, the biological sample card may be brought in close proximity with the computing device 902. For example, device 902 may be a smartphone or a tablet computer that a health professional uses to, among other things, transfer data to a biological sample card. In such implementations, the software may include controls 906a, 906c, and 906d. After inputting information from the patient (see discussion regarding FIG. 9D), the health professional can select control 906a to transfer the data to the patient's biological sample card. Accordingly, the patient information, sample collection information, and/or unique identifier are stored electronically on the biological sample card and the disclosed technology thereby reduces errors associated with handwritten patient information on biological sample cards.

In some implementations, upon transmission of the patient information, sample collection information, and/or unique identifier on the biological sample card to the computing device 902, the computing device 902 provides the user with an indication of success. Such alert an mechanism may include, in some examples, audio, graphic, and/or tactile feedback.

In some implementations, such as at a screening lab, the software does not include the control 906a for transferring data to the biological sample card. Screening laboratories may only need to read information from biological sample cards. When the biological sample card is received by the screening lab, the testing laboratory may use the software to transfer data from the biological sample card, thus eliminating errors associated with handwritten patient information. Furthermore, the use of biological sample card transmission and storage devices can reduce manual labor at screening laboratories and thereby may reduce the amount of time it takes for biological test results to be sent to the hospital.

In some implementations, a third menu control 906c labeled “Patient Information Menu”, as shown in FIG. 9A, provides the user, upon selection, with a menu within the display region 908 where the user may input or review information associated with a patient. Information may be entered using the patient information menu and the information may be transferred to a biological sample card via the “Transfer Data To Biological Sample Card” control 906a. If data is transferred to the device 902 from a biological sample card using the “Transfer Data From Biological Sample Card” control 906b, the data may be viewed by accessing the “Patient Information Menu” 906c. Additionally, the “Patient Information Menu” 906c may be used to edit this information if there are mistakes or to input the status of any tests being performed on the biological samples associated with the relevant biological sample card.

Selection of the “Log Out” control 906d, in some implementations, results in exiting the software application.

Turning to FIG. 9B, a screen shot 920 of a software application executing on the computing device 902, in some implementations, is presented to a user upon selection of the “Transfer Data To Biological Sample Card” menu control 906a or “Transfer Data From Biological Sample Card” menu control 906b (as shown in FIG. 9A). The screen shot 920, in some implementations, includes a message 922 directing the user to “Press Button Below to Transfer Data with this Device.” In some implementations, if data is being transferred to a biological sample card from the device 902, the data may be displayed on the display region 908 prior to transfer. Beneath the message 922, in some implementations, a button-style touch screen control 924 is presented. In some implementations, upon selection of the touch screen control 924, the computing device 902 provides an indication to the user that transfer is underway. In some examples, the indication may include audio (e.g., “white noise”, “elevator music”, an audible hum, an egg timer tick, or other consistent audible feedback indicating a process is taking place, etc.), graphic (e.g., brightness variation, change of screen appearance, change of control appearance, textual message indicating a process is taking place, etc.), or tactile (e.g., pulsed or constant vibration, etc.) feedback to the user from the computing device 902.

If data transfer between the computing device 902 and the biological sample card is successful, the computing device 902, in some implementations, provides an audio (e.g., verbal message, fanfare, one or more chirps, beeps, or other tones, etc.), graphic (e.g., brightness variation, change of screen appearance, change of control appearance, textual message indicating success, image, visual cue, etc.), and/or tactile (e.g., pulsed or constant vibration, etc.) indication of success.

Turning to FIG. 9C, as illustrated in a screen shot 940, a patient information menu 942 is displayed when the user selects the patient information menu 906c (FIG. 9A). In some implementations, the patient information menu 942 includes a “View Patient Information” control 944, an “Input Patient Information” control 946, an “Input Test Status and/or Results” control 948, and a “Log Out” control 950. Selection of the “View Patient Information” control 944, in some implementations, provides the user with an interface for entering or viewing descriptive information about the patient associated with the relevant biological sample card.

The “Input Test Status and/or Results” control 948, upon selection, may provide the user with an interface for entering or viewing descriptive information about the status of a newborn screening test. The status may include whether the sample was received, whether the sample is abnormal, whether the sample is usable, what tests are being performed, and the tests results. The hospital may monitor the status of a biological sample card and related testing using software application 208 described above in relation to FIG. 2.

The “Log Out” control 950 within the settings menu 942, in some implementations, provides the user with a mechanism, upon selection, to log out of the application.

Turning to FIG. 9D, a screen shot 960 of a software application executing on the computing device 902, in some implementations, is presented to a user upon selection of the “Input Patient Information” menu control 946 (as described in relation to FIG. 9C). Selection of the “Input Patient Information” control 946, in some implementations, provides the user with a graphical user interface 962 along with a number of data entry regions for entering or viewing the patient information described above. The data entry regions may include one or more of any number of the following: a window (e.g., collapsible panel, accordion, modal window, dialog box, palette window, inspector window, utility window, or frame), a text box, a button, a drop-down list, a list box, a combo box, a check box, a radio button, a cycle button, a spinner, a menu (e.g., context menu, pie menu, ribbon), a menu bar, a tab, a toggle switch, and/or a scroll bar.

Hospitals, midwives, or other medical personnel may input patient information into this interface directly without having to handwrite the information on the biological sample card or read handwritten information from the biological sample card. Thus, errors caused by misreading handwritten patient information are reduced.

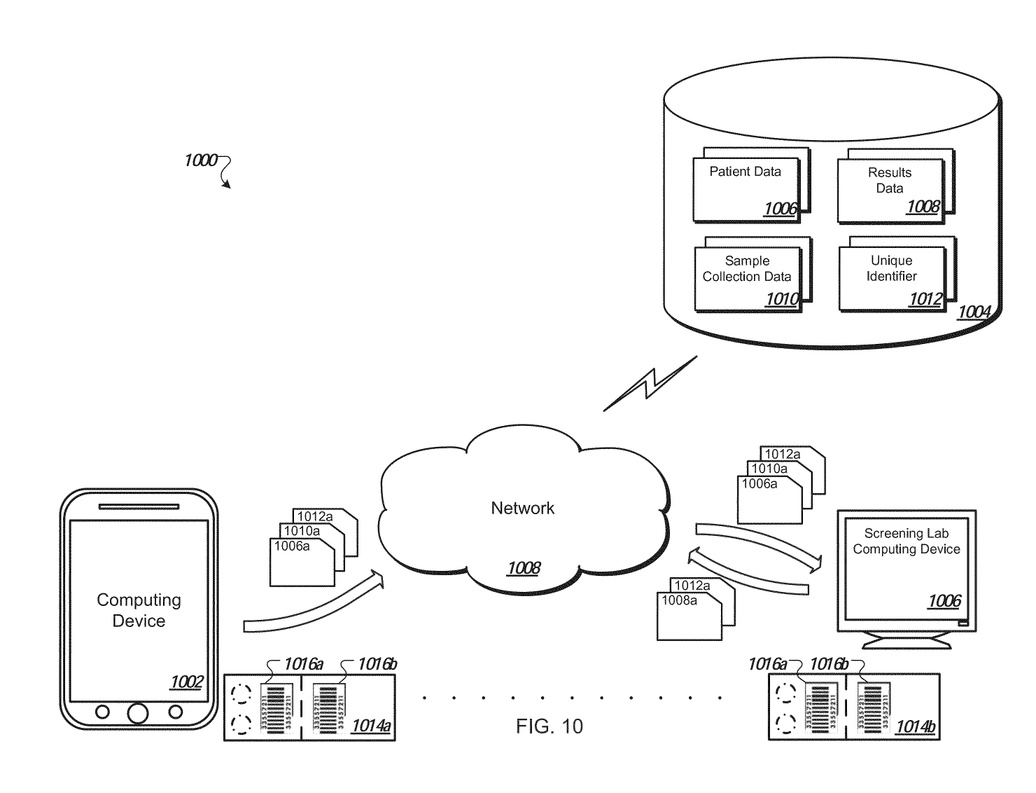

As shown in FIG. 10, in some implementations, a cloud computing environment 1000 is provided for sharing information related to biological sample testing.

In some implementations, a computing device 1002 is used to collect information relating to a biological sample. In some implementations, the computing device 1002 is a smart phone, handheld multimedia entertainment device, personal computer, personal digital assistant, tablet computer, notebook computer, or laptop computer.

The information may include patient data 1006a, a unique identifier 1010a, and/or sample collection data 1010a. The information may be obtained from scanning a machine-readable indicia, manually entering information into the computing device, or scanning a biological sample card 1014 equipped with a biological sample card transmission and storage device as described in reference to FIG. 1. The various methods of inputting information into computing device 102 are described in relation to FIG. 1 above. As described in relation to FIG. 1 above, after loading data, such as patient data 1006a, into computing device 1002, the computing device may transfer the data to the biological sample card 1014. The data transferred to the biological sample card 1014 may include the patient data 1006a, sample collection data 1010a, and/or the unique identifier 1012a.

In some implementations, the unique identifier 1012a is marked on the biological sample card 1014 in a machine-readable indicia 1016. In some implementations, the unique identifier 1012a is stored on a biological sample card transmission and storage device as described in relation to FIG. 1. After collecting the data (e.g. 1006a, 1010a) related to the biological sample card 1014, the biological sample card 1014 can be sent from a sample collection location to a testing laboratory. The biological sample card 1014 may contain a perforation as described in relation to FIG. 1 (110). The biological sample card 1014 may be split along the perforation into two portions. In some implementations, both portions of the biological sample card 1014 includes the machine-readable indicia 1016. The perforation may split the machine-readable indicia 1016 in half or the machine-readable indicia 1016 may be provided on each portion of the biological sample card 1014 such that when the biological sample card 1014 is split along the perforation, each portion contains a copy of the machine-readable indicia 1016 [e.g. 1016a, 1016b].

In some implementations, the computing device 1002 transfers the patient data 1006a, sample collection data 1010a, and/or unique identifier to a data center 1004 via a network 1008. The network may be compressed, encrypted, and/or utilize secure connections. The data center 1004 may provide a security system for requesting, sending and/or accessing data from the data center 1004 such as requiring a user to log into the data center or be authenticated.

In some implementations, the computing device 1002 transfers the data to a computing device located at a hospital or other medical facility via the network 1008 and then the computing device located at the hospital or other medical facility can maintain the data and/or transfer the data to the data center 1004. The computing device 1002 may transfer the data to the data center 1104 directly via the network 1008.

The data center 1004 may be located at the hospital requesting the biological sample be tested or at a third party location. The data center 1004 receives, via network 1008, and stores patient data 1006 results data 1008, sample collection data 1010, and/or status information. The various data including patient data 1006, sample collection data 1010, and/or the status information, may be associated using a set of unique identifiers. (e.g. per patient, per sample, a barcode). In some implementations, the unique identifier is a machine-readable indicia such as a barcode identification. Each type of data may be stored in a central database or in its own database. In a particular example, the unique identifier may be assigned to a blood sample collected from a newborn named John Doe. The data center 1004 receives the data and stores the patient data 1006a and sample collection data 1010a with the unique identifier 1012a. If the data center 1004 receives a request for information related to the unique identifier 1012a, the data center 1004 can retrieve the patient data 1006a and sample collection data 1010a associated with that unique identifier 1012 as described below.

The patient information records 1006 relate to information about patient from whom biological samples have been collected, such as demographic information, as described in relation to FIG. 1. Patient information may include: patient identification number, patient first name, patient last name, patient address, patient birth date, patient birth time, patient birth weight, patient gender, patient ethnic code, repeat sample, the patient's parental information, or whether the patient has had a blood transfusion, received steroids, received antibiotics, whether the patient was born prematurely, whether the baby is sick, how the baby is feeding, whether the parents provided consent to testing, and/or whether the parents consent to using the specimen for research.

The results information records 1008 include the results from testing the biological samples. The unique identifiers 1012 are identifiers used to link patient data records 1006, results records 1008, and sample data records 1010 [e.g. linking information provided to the data center 1004 by computing device 1002 with results records 1008 provided to the data center 1004 by the screening lab] as described below.

The sample collection data 1010a may include a date stamp, time stamp, information regarding the device used to collect information, information about the submitter of patient information such as a name and/or unique employee identifier, and/or location information relating to when and where the biological sample was collected. In some implementations, the sample collection information 1010a includes information regarding the testing laboratory such as email information, phone number information, fax information, other contact information, and/or a user ID for logging into the data center 1004, a web portal, or a software application to access relevant data for testing. In some implementations, the sample collection information 1010a includes contact information for the entity who submitted the biological sample for testing, such as a hospital or other medical facility. The contact information may include one or more phone numbers, email addresses, and/or fax numbers for contacting the relevant party or parties at the entity who submitted the biological sample for testing. The contact information may be for a primary care physician, hospital, and/or midwife.

In some implementations, the sample collection information 1010a includes healthcare facility information such as a name of a healthcare professional, a telephone number, an address, a hospital name, a testing laboratory name, and/or a testing laboratory telephone number.

The status information may include information provided by a testing laboratory to the data center 1004 related to the status of tests for a given biological sample. Status information may include whether the sample was received, whether the sample is usable, whether the testing is ongoing, whether the testing is complete, whether additional samples are required, whether the sample is abnormal, an indication of prior abnormal results, the availability of screening results, what tests are being performed, the tests results, the location of the sample, and follow-up activities related to the patient's diagnosis.

In some implementations, the data center 1004 identifies sample data 1010b related to previous tests 1008a for a given patient based on a portion of the patient data 1006a. The data center 1004 may associate the previous test information 1008a with the sample collection data 1010a. In some implementations, the data center 1004 may associate the previous test information 1008a with the unique identifier 1012a for the given patients current biological sample.

In some implementations, the data center 1004 receives, via the network 1008, a request for data. The request may comprise the unique identifier 1012a. In response to the request, the data center 1004 may provide at least a portion of the patient data 1006a and the sample collection data 1010a associated with the unique identifier 1012a provided in the request. In some implementations, the request is sent by a testing laboratory computing device 1018. The data center 1004 sends the testing laboratory computing device 1018 at least a portion of the patient data 1006a and the sample collection data 1010a associated with the unique identifier 1012a provided by the testing laboratory computing device 1018. In some implementations, the data center 1004 includes the previous test information 1008a for the patient in the data 1006a it sends to the testing laboratory computing device 1018 in response to the request. The previous test information 1008a may be used by the testing laboratory to identify previous abnormal test results for the patient and/or determine what tests need to be run on the current biological sample.

The data center 1004 may include settings that can be set by the data center 1004, screening lab, hospital, or party requesting the sample be tested. The settings may include what type of information is shared with screening laboratories. The information shared may be limited to information necessary to conduct the tests and sensitive information may be withheld from the testing laboratory for privacy reasons.

In some implementations, the testing laboratory receives inventory information from the hospital or data center 1004 via the network 1008. The inventory information may be provided to the testing laboratory before the testing laboratory receives the biological samples listed in the inventory information. The inventory information may be used by the testing laboratory to verify that the correct samples have been received by the testing laboratory. In some implementations, intelligent shelving may be used as described in relation to FIG. 1. The inventory information may be sent to the testing laboratory via an email, a messaging center, a text message, a letter, or a web portal.

In some implementations, the data center 1004 receives an alert from the testing laboratory. The alert may relate to status information the testing laboratory provides the data center 1004. Upon receipt of the alert, the data center 1004 may provide a message to the contact information associated with the relevant unique identifier (e.g. derived from patient information 1006a or sample data 1010a). In some implementations, the message is a text message, email, a prerecorded voicemail message, a phone call, a fax, or other means of communicating the alert to the contacts. For example, a hospital may receive an alert from the data center 1004 after the data center 1004 receives status information from the testing laboratory. The status information may be the time when the testing laboratory received the sample. The hospital may use this information to see if there are opportunities to improve the amount of time it takes for a sample to reach the testing laboratory.

In some implementations, the data center 1004 receives screening results 1008a from the testing laboratory. The data center 1004 may associate the screening results 1008a with the relevant unique identifier 1012a. The unique identifier 1012a corresponding to the screening results 1008a may be sent with the screening results 1008a by the testing laboratory. The data center 1004 can store the screening results 1008a with the other data associated with the unique identifier 1012a. In some implementations, the data center 1004 alerts the hospital or party that submitted the biological sample for testing. The alert may notify the submitting party that the test results have been submitted to the data center 1004 or may send the test results to the contact information of the submitting party.

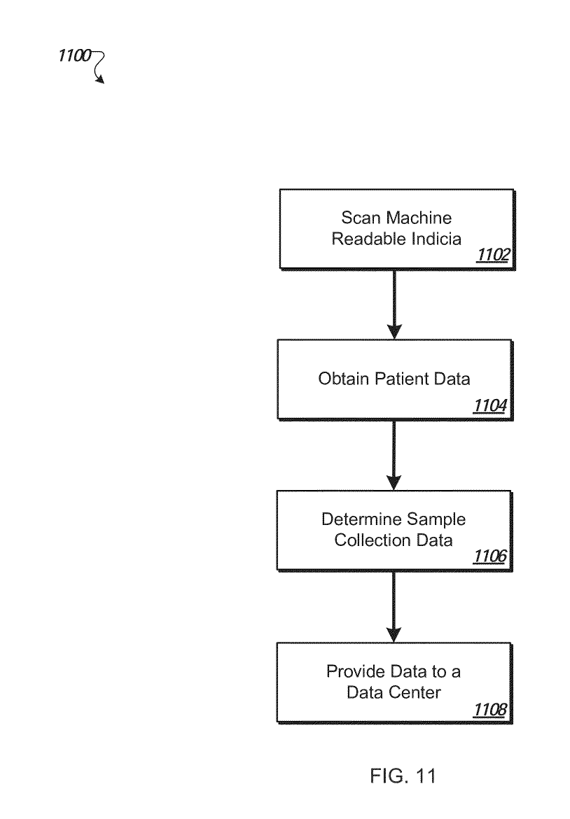

FIG. 11 illustrates a flow chart describing an example method 1100 for collecting and transmitting information related to a biological sample to a data center.

As described above, a hospital or other medical facility may need to submit a biological sample to a testing laboratory for testing. Prior to submission of the sample to the screening lab, in some implementations, the submitting party may scan, using a scanner of a computing device, a machine-readable indicia (1102). The machine-readable indicia may include a barcode, two-dimensional barcode, three-dimensional barcode, QR code, and/or matrix barcode. In some implementations, the machine-readable indicia is presented on a biological sample card for stably storing the biological sample collected from a patient. In some implementations the machine-readable indicia includes a unique identifier, data related to a medical facility (e.g. facility name, treating physician, location, contact information), a type of biological sample (e.g. newborn blood card, biological tissue card, biological genetics card, or a blood/urine sample), and/or sample collection data.

In some implementations, patient data is obtained (1104). The patient information may be associated with the unique identifier read from the machine-readable indicia. Patient information may include: patient identification number, patient first name, patient last name, patient address, patient birth date, patient birth time, patient birth weight, patient gender, patient ethnic code, repeat sample, the patient's parental information, or whether the patient has had a blood transfusion, received steroids, received antibiotics, whether the patient was born prematurely, whether the baby is sick, how the baby is feeding, whether the parents provided consent to testing, and/or whether the parents consent to using the specimen for research.

In some implementations, the computing device determines sample collection data (1106). The sample collection data may include a date stamp, time stamp, information regarding the device used to collect information, information about the submitter of patient information such as a name and/or unique employee identifier, and/or location information relating to when and where the biological sample was collected. In some implementations, the sample collection information includes information regarding the testing laboratory such as email information, phone number information, fax information, other contact information, and/or a user ID for logging into the data center, a web portal, or a software application to access relevant data for testing. In some implementations, the sample collection information includes contact information for the entity who submitted the biological sample for testing, such as a hospital or other medical facility. The contact information may include one or more phone numbers, email addresses, and/or fax numbers for contacting the relevant party or parties at the entity who submitted the biological sample for testing. The contact information may be for a primary care physician, hospital, and/or midwife.

In some implementations, the sample collection information includes healthcare facility information such as a name of a healthcare professional, a telephone number, an address, a hospital name, a testing laboratory name, and/or a testing laboratory telephone number.

In some implementations, the computing device provides the patient data, the sample collection data, and the unique identifier to a data center (1108). The data center may be a server, server farm, database system, cloud based storage system, or remote computer. As described above in reference to FIG. 10, the unique identifier can be associated with the other data collected and submitted to the data center so that any party with the unique identifier and, in some implementations, permission, can obtain a portion of the information associated with the unique identifier.

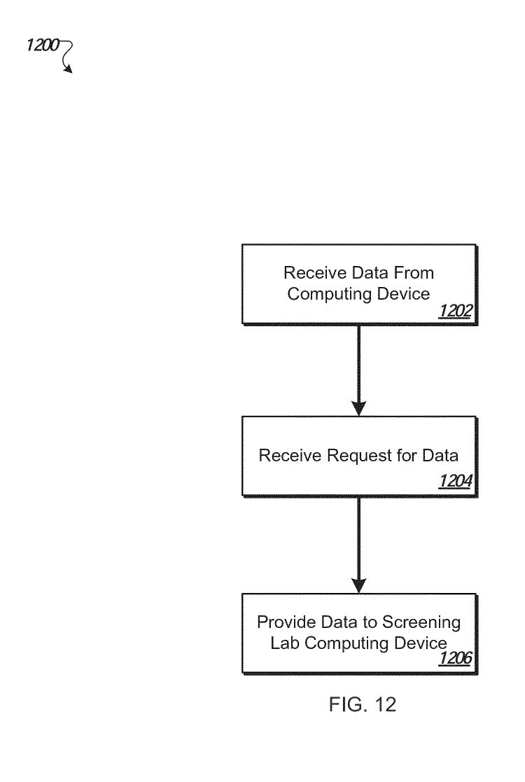

FIG. 12 illustrates a flow chart describing an example method 1200 for receiving and transmitting information related to a biological sample.

In some implementations, patient data, sample collection data, and a unique identifier are received from a computing device (1202). A data center, for example, can receive and store the unique identifier and associate the unique identifier with the other data received by the data center so that any party with the unique identifier and, in some implementations, permission, can obtain a portion of the information associated with the unique identifier. The computing device may be a computing device located at a hospital or other medical facility that is submitting the biological sample for testing. The computing device located at the hospital or other medical facility may be a smart phone, handheld multimedia entertainment device, personal computer, personal digital assistant, tablet computer, notebook computer, or laptop computer.

After receiving the data, in some implementations, a request for the data is received (1204). The request may be from a computing device of a testing laboratory. The computing device of the testing laboratory may be a smart phone, handheld multimedia entertainment device, personal computer, personal digital assistant, tablet computer, notebook computer, or laptop computer. The request may include the unique identifier for the data the testing laboratory wants to receive. In some implementations, the data center validates the requesting party is authorized to request data associated with the provided unique identifier prior to providing the data to the requesting party.

After receiving a request, in some implementations, the data associated with the provided unique identifier is provided to the requesting party such as a testing laboratory (1206). The testing laboratory may use this data to determine what tests need to be done as described in relation to FIG. 11.

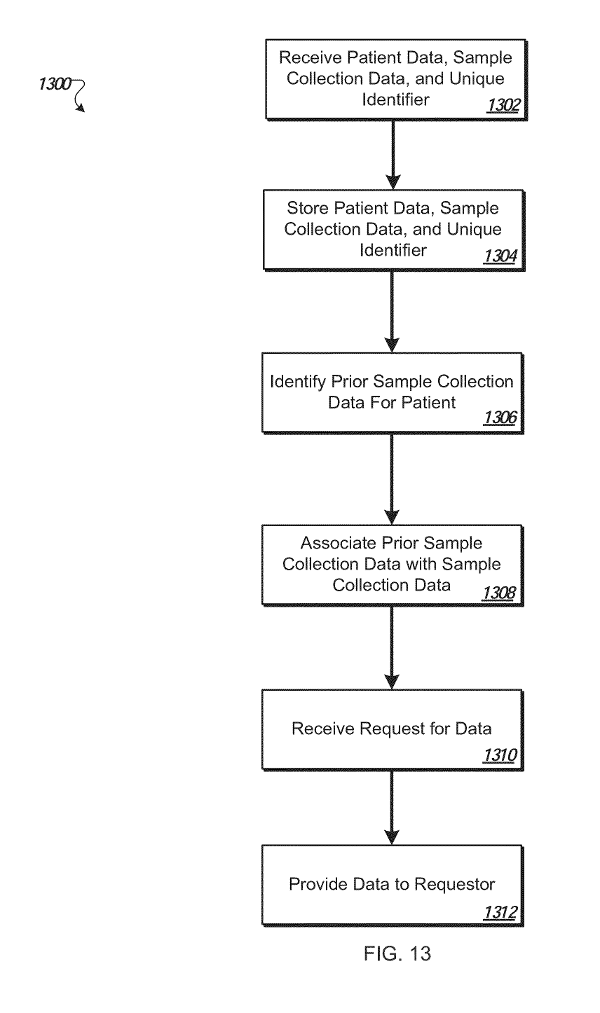

FIG. 13 illustrates a flow chart describing an example method 1300 for receiving and transmitting information related to a biological sample.

In some implementations, patient data, sample collection data, and a unique identifier are received from a computing device (1302). After receiving the patient data, sample collection data, and/or unique identifier, in some implementations, the data is stored (1304). The unique identifier can be associated with the other data received by the data center so that any party with the unique identifier and, in some implementations, permission, can obtain a portion of the information associated with the unique identifier. The computing device may be a computing device located at a hospital or other medical facility that is submitting the biological sample for testing. The computing device located at the hospital or other medical facility may be a smart phone, handheld multimedia entertainment device, personal computer, personal digital assistant, tablet computer, notebook computer, or laptop computer. In some implementations, previous test information for a patient is identified (1306).

The data center may identify previous test information based on part of the patient data and/or sample collection data received with a unique identifier. The previous test information may be used by a testing laboratory to identify previous abnormal test results for the patient and/or determine what tests need to be run on the current biological sample.

In some implementations, the previous test information is associated with the unique identifier provided with the patient date and sample collection data (1308) received in step 1302. Accordingly, when a testing laboratory requests information related to a unique identifier, the past test information may be sent to the testing laboratory.

In some implementations, a request for the data is recorded (1310). The request may be from a computing device of a testing laboratory. The computing device of the testing laboratory may be a smart phone, handheld multimedia entertainment device, personal computer, personal digital assistant, tablet computer, notebook computer, or laptop computer. The request may include the unique identifier for the data the testing laboratory wants to receive. In some implementations, the data center validates the requesting party is authorized to request data associated with the provided unique identifier prior to providing the data to the requesting party.

After receiving a request, in some implementations, the data associated with the provided unique identifier is provided to the requesting party such as a testing laboratory (1312). The testing laboratory may use this data to determine what tests need to be conducted.

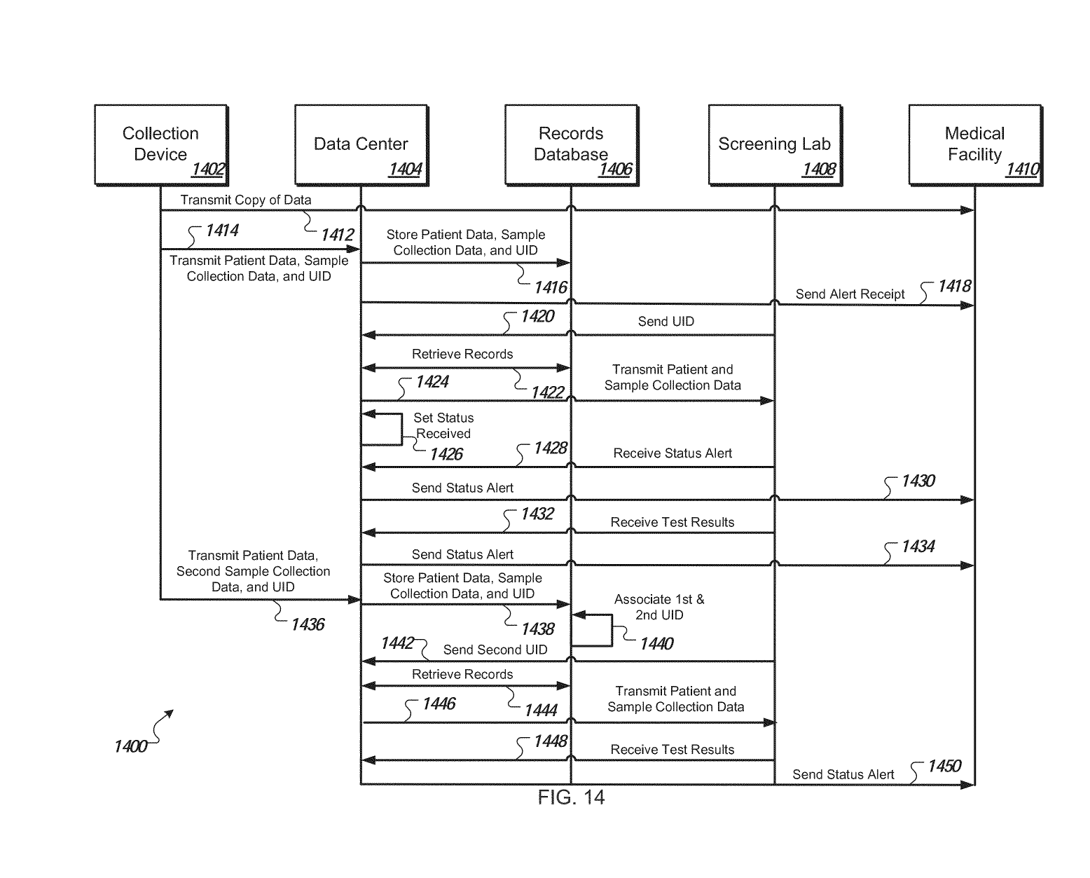

FIG. 14 illustrates a chart describing a system and method 1400 for communicating data regarding a biological sample to and from a data center.

In some implementations, a collection device 1402 receives patient data, sample collection data, and/or a unique identifier as explained in reference to FIG. 1. In some implementations, the collection device 1402 generates the sample collection data itself or using a software application. The collection device 1402 may be a personal computer, laptop, smart phone, handheld multimedia entertainment device, personal digital assistant, or tablet computer. The collection device 1402 may transmit a copy of the data (1412) to a medical facility 1410 that is requesting a biological sample be tested. The medical facility 1410 may use the data in a software program such as Specimen Gate®, eReports™, or Labworks™ Laboratory Information Management System, all by PerkinElmer of Waltham, Mass. The software program may be accessed from one or more locations and may communicate directly or indirectly with a software program of the testing laboratory.

In some implementations, the collection device 1402 transmits, via a network, the patient data, sample collection data, and/or unique identifier (UID) (1414) to a data center 1404. The data center 1004 receives, via a network, and stores the patient data, sample collection data, results data, and/or status information (1416) in a records database 1406. The data may be associated using the unique identifier (e.g. a unique identifier per patient, per sample, a barcode). The association may be done by the collection device 1402 or the data center 1404. In some implementations, the unique identifier is a machine-readable indicia such as a barcode identification. If the data center 1404 receives a request for information related to a specific unique identifier, the data center 1404 can retrieve the patient data, sample collection data, and any other data associated with that unique identifier.

In some implementations, after receiving and storing the data, the data center 1404 may send a status update or alert (1418) to the medical facility 1410 to notify the medical facility 1410 of the status of the biological sample testing. The alert or status update may notify the medical facility 1410 at the data center has received the patient date, sample collection data, and/or unique identifier. The alert or status update may notify the medical facility 1410 that a testing laboratory 1408 has received the biological sample. The data center 1404 may be notified by the testing laboratory 1408 that the testing laboratory 1408 has received the biological sample before the data center 1404 sends the alert to the medical facility 1410. Alerts and status updates may include a message that is provided to contact information associated with the relevant unique identifier (1404). In some implementations, the message is a text message, email, a prerecorded voicemail message, a phone call, a fax, or other means of communicating the alert to the contacts. The message may be used to notify a representative of the party who submitted the biological sample for testing of the alert.

In some implementations, the testing laboratory 1408 sends a unique identifier (1420) to the data center 1404. The unique identifier may be from a biological sample card the testing laboratory 1408 received from a medical facility 1410. The unique identifier may be stored in a biological sample card transmission and storage device, a machine-readable indicia, or printed on the biological sample card. In response to receipt of the unique identifier, the data center 1404 may retrieve records (1422) associated with that unique identifier from the records database 1406. After retrieving the records, the data center 1404 may transmit patient data and/or sample collection data (1424) to the testing laboratory 1408. The testing laboratory 1408 may use the data to determine the type of tests to run against the biological sample received from the biological sample card. The testing laboratory 1408 can make this determination based on demographic information such as state, ethnicity, and whether it is a first test or follow-up test.

In some implementations, the data center 1404 updates the status information (1426) so that the medical facility 1410 is aware of the status of the biological sample testing. The data center 1404 may provide an alert to the medical facility 1410 every time the status information is updated. The data center 1404 may set the status (1426) when the testing laboratory 1408 receives the patient data and/or sample collection data.

In some implementations, the data center 1404 receives a status alert (1428) from the screening center 1408. The status alert may include the status information of a biological sample test and the unique identifier of the biological sample for which the status is being updated. The status information may include whether the sample was received, whether the sample is usable, whether the testing is ongoing, whether the testing is complete, whether additional samples are required, whether the sample is abnormal, an indication of prior abnormal results, the availability of screening results, what tests are being performed, the tests results, the location of the sample, and follow-up activities related to the patient's diagnosis.

In some implementations, after receiving a status alert (1428), the data center 1404 may send a status update or alert (1430) to the medical facility 1410 to notify the medical facility 1410 of the status alert (1428).

In some implementations, the data center 1404 receives test results (1432) from the screening center 1408. After receiving the test results, the data center 1404 may update the records database 1406 to include the test results data and update the status of the test. The data center 1404 may send an alert (1434) to the medical facility 1410 to notify them the test results have been received by the data center 1404. The data center 1404 may provide the medical facility 1410 with the test results automatically or upon request from the medical facility 1410. In some implementations, the test results may be accessed by a member of the medical facility through a web-based portal.

In some implementations, the collection device 1402 transmits patient data, second sample collection data, and a second unique identifier (1436) to the data center 1404 if a first test result was unsatisfactory and a new biological sample has been collected from the same patient for testing. Test results may be unsatisfactory, in some examples, if the volume of the biological sample is inadequate or the biological sample comes in contact with certain substances, such as a lotion or powder.

The data center 1004 receives, via a network, and stores the patient data, sample collection data, results data, and/or status information (1438) in a records database 1406. The data may be associated with the second unique identifier. The association may be done by the collection device 1402 or the data center 1404. In some implementations, the records database 1406 associates the original unique identifier with the second unique identifier (1440). In some implementations, this association is done by the data center 1404. The original and second unique identifiers are associated so that a party requesting data associated with either unique identifier receives the data associated with both unique identifiers.

In some implementations, a testing laboratory 1408 may send the second unique identifier (1442) to the data center 1404. The unique identifier may be from a second biological sample card for a given patient the testing laboratory 1408 received from a medical facility 1410. In response to receipt of the unique identifier, the data center 1404 may retrieve records (1444) associated with the second unique identifier and the first unique identifier from the records database 1406. After retrieving the records, the data center 1404 may transmit patient data and/or sample collection data (1446) to the testing laboratory 1408. The testing laboratory 1408 may use the data to determine the type of tests to run against the biological sample received from the second biological sample card. Specifically, the testing laboratory 1408 may use the data pertaining to the first unique identifier, including whether and why the first test results were abnormal, to determine the types of tests to run.

In some implementations, the data center 1404 receives test results (1448) from the screening center 1408. After receiving the test results, the data center 1404 may update the records database 1406 to include the test results data and update the status of the test. The data center 1404 may send an alert to the medical facility 1410 to notify them the test results have been received by the data center 1404. The data center 1404 may provide the medical facility 1410 with the test results automatically or upon request from the medical facility 1410. In some implementations, the test results may be accessed by a member of the medical facility through a web-based portal.

Throughout the method described with reference to FIG. 14, alerts and status updates may be provided to and from the collection device 1402 and testing laboratory 1408 at various steps besides those described above. Alerts and status updates may be a message that is provided to contact information associated with the relevant unique identifier. In some implementations, the message is a text message, email, a prerecorded voicemail message, a phone call, a fax, or other means of communicating the alert to the contacts. The message may be used to notify a representative of the party who submitted the biological sample for testing of the alert. Status information may include whether the sample was received, whether the sample is usable, whether the testing is ongoing, whether the testing is complete, whether additional samples are required, whether the sample is abnormal, an indication of prior abnormal results, the availability of screening results, what tests are being performed, the tests results, the location of the sample, and follow-up activities related to the patient's diagnosis.

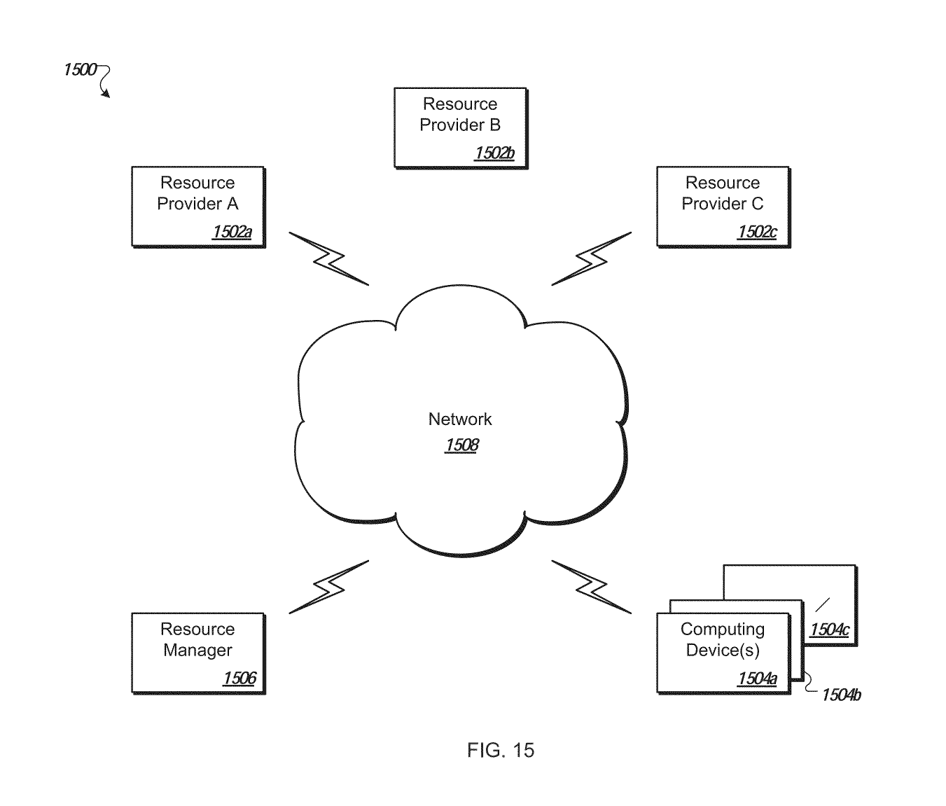

As shown in FIG. 15, an implementation of an exemplary cloud computing environment 1500 for localized transferring data to/from electronically labeled items is shown and described. In brief overview, the cloud computing environment 1500 may include one or more resource providers 1502a, 1502b, 1502c (collectively, 1502). Each resource provider 1502 may include computing resources. In some implementations, computing resources includes any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1502 may be connected to any other resource provider 1502 in the cloud computing environment 1500. In some implementations, the resource providers 1502 may be connected over a computer network 1508. Each resource provider 1502 may be connected to one or more computing device 1504a, 1504b, 1504c (collectively, 1504), over the computer network 1508.

The cloud computing environment 1500 may include a resource manager 1506. The resource manager 1506 may be connected to the resource providers 1502 and the computing devices 1504 over the computer network 1508. In some implementations, the resource manager 1506 may facilitate the provision of computing resources by one or more resource providers 1502 to one or more computing devices 1504. The resource manager 1506 may receive a request for a computing resource from a particular computing device 1504. The resource manager 1506 may identify one or more resource providers 1502 capable of providing the computing resource requested by the computing device 1504. The resource manager 1506 may select a resource provider 1502 to provide the computing resource. The resource manager 1506 may facilitate a connection between the resource provider 1502 and a particular computing device 1504. In some implementations, the resource manager 1506 may establish a connection between a particular resource provider 1502 and a particular computing device 1504. In some implementations, the resource manager 1506 may redirect a particular computing device 1504 to a particular resource provider 1502 with the requested computing resource.

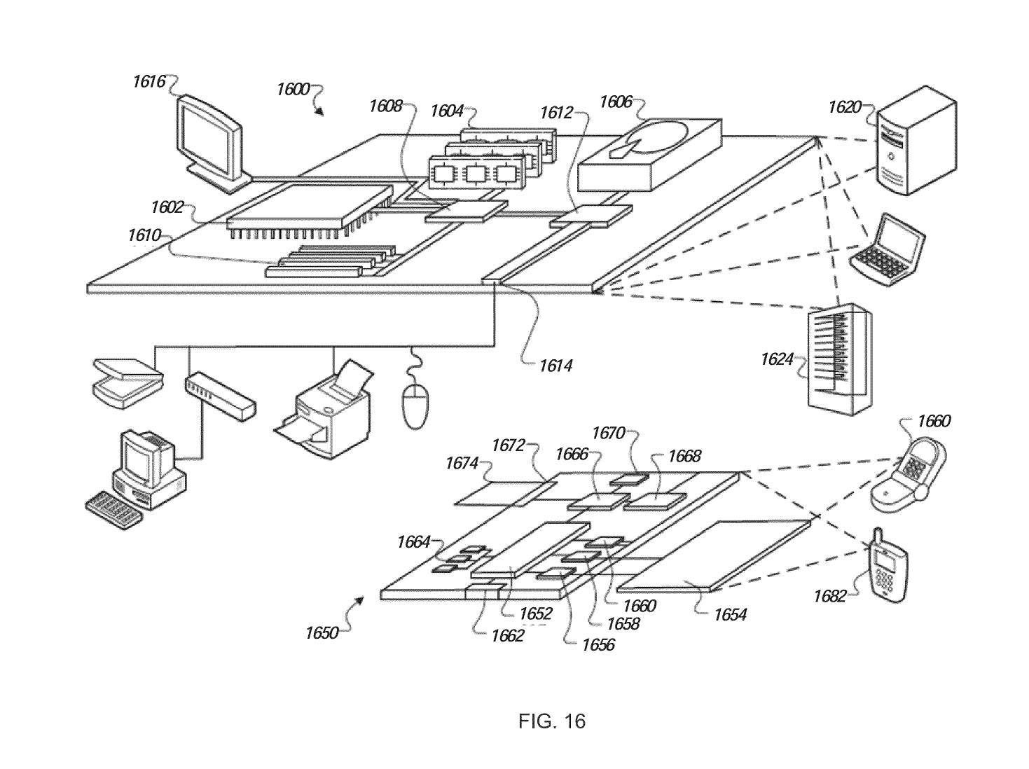

FIG. 16 shows an example of a computing device 1600 and a mobile computing device 1650 that can be used to implement the techniques described in this disclosure. The computing device 1600 is intended to represent various forms of digital computers, such as laptops, desktops, workstations, personal digital assistants, servers, blade servers, mainframes, and other appropriate computers. The mobile computing device 1650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1600 includes a processor 1602, a memory 1604, a storage device 1606, a high-speed interface 1608 connecting to the memory 1604 and multiple high-speed expansion ports 1610, and a low-speed interface 1612 connecting to a low-speed expansion port 1614 and the storage device 1606. Each of the processor 1602, the memory 1604, the storage device 1606, the high-speed interface 1608, the high-speed expansion ports 1610, and the low-speed interface 1612, are interconnected using various busses, and may be mounted on a common motherboard or in other manners as appropriate. The processor 1602 can process instructions for execution within the computing device 1600, including instructions stored in the memory 1604 or on the storage device 1606 to display graphical information for a GUI on an external input/output device, such as a display 1616 coupled to the high-speed interface 1608. In some implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1604 stores information within the computing device 1600. In some implementations, the memory 1604 is a volatile memory unit or units. In some implementations, the memory 1604 is a non-volatile memory unit or units. The memory 1604 may also be another form of computer-readable medium, such as a magnetic or optical disk.

The storage device 1606 is capable of providing mass storage for the computing device 1600. In some implementations, the storage device 1606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1602), perform one or more methods, such as those described above. The instructions can also be stored by one or more storage devices such as computer- or machine-readable mediums (for example, the memory 1604, the storage device 1606, or memory on the processor 1602).

The high-speed interface 1608 manages bandwidth-intensive operations for the computing device 1600, while the low-speed interface 1612 manages lower bandwidth-intensive operations. Such allocation of functions is an example only. In some implementations, the high-speed interface 1608 is coupled to the memory 1604, the display 1616 (e.g., through a graphics processor or accelerator), and to the high-speed expansion ports 1610, which may accept various expansion cards (not shown). In the implementation, the low-speed interface 1612 is coupled to the storage device 1606 and the low-speed expansion port 1614. The low-speed expansion port 1614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1600 may be implemented in a number of different forms. For example, it may be implemented as a standard server 1620, or multiple times in a group of such servers. In addition, it may be implemented in a personal computer such as a laptop computer 1622. It may also be implemented as part of a rack server system 1624. Alternatively, components from the computing device 1600 may be combined with other components in a mobile device (not shown), such as a mobile computing device 1650. Each of such devices may contain one or more of the computing device 1600 and the mobile computing device 1650, and an entire system may be made up of multiple computing devices communicating with each other.

The mobile computing device 1650 includes a processor 1652, a memory 1664, an input/output device such as a display 1654, a communication interface 1666, and a transceiver 1668, among other components. The mobile computing device 1650 may also be provided with a storage device, such as a micro-drive or other device, to provide additional storage. Each of the processor 1652, the memory 1664, the display 1654, the communication interface 1666, and the transceiver 1668, are interconnected using various buses, and several of the components may be mounted on a common motherboard or in other manners as appropriate.

The processor 1652 can execute instructions within the mobile computing device 1650, including instructions stored in the memory 1664. The processor 1652 may be implemented as a chipset of chips that include separate and multiple analog and digital processors. The processor 1652 may provide, for example, for coordination of the other components of the mobile computing device 1650, such as control of user interfaces, applications run by the mobile computing device 1650, and wireless communication by the mobile computing device 1650.

The processor 1652 may communicate with a user through a control interface 1658 and a display interface 1656 coupled to the display 1654. The display 1654 may be, for example, a TFT (Thin-Film-Transistor Liquid Crystal Display) display or an OLED (Organic Light Emitting Diode) display, or other appropriate display technology. The display interface 1656 may include appropriate circuitry for driving the display 1654 to present graphical and other information to a user. The control interface 1658 may receive commands from a user and convert them for submission to the processor 1652. In addition, an external interface 1662 may provide communication with the processor 1652, so as to enable near area communication of the mobile computing device 1650 with other devices. The external interface 1662 may provide, for example, for wired communication in some implementations, or for wireless communication in some implementations, and multiple interfaces may also be used.

The memory 1664 stores information within the mobile computing device 1650. The memory 1664 can be implemented as one or more of a computer-readable medium or media, a volatile memory unit or units, or a non-volatile memory unit or units. An expansion memory 1674 may also be provided and connected to the mobile computing device 1650 through an expansion interface 1672, which may include, for example, a SIMM (Single In Line Memory Module) card interface. The expansion memory 1674 may provide extra storage space for the mobile computing device 1650, or may also store applications or other information for the mobile computing device 1650. Specifically, the expansion memory 1674 may include instructions to carry out or supplement the processes described above, and may include secure information also. Thus, for example, the expansion memory 1674 may be provide as a security module for the mobile computing device 1650, and may be programmed with instructions that permit secure use of the mobile computing device 1650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1652), perform one or more methods, such as those described above. The instructions can also be stored by one or more storage devices, such as one or more computer- or machine-readable mediums (for example, the memory 1664, the expansion memory 1674, or memory on the processor 1652). In some implementations, the instructions can be received in a propagated signal, for example, over the transceiver 1668 or the external interface 1662.

The mobile computing device 1650 may communicate wirelessly through the communication interface 1666, which may include digital signal processing circuitry where necessary. The communication interface 1666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1668 using a radio-frequency. In addition, short-range communication may occur, such as using a Bluetooth, WiFi, or other such transceiver (not shown). In addition, a GPS (Global Positioning System) receiver module 1670 may provide additional navigation- and location-related wireless data to the mobile computing device 1650, which may be used as appropriate by applications running on the mobile computing device 1650.

The mobile computing device 1650 may also communicate audibly using an audio codec 1660, which may receive spoken information from a user and convert it to usable digital information. The audio codec 1660 may likewise generate audible sound for a user, such as through a speaker, e.g., in a handset of the mobile computing device 1650. Such sound may include sound from voice telephone calls, may include recorded sound (e.g., voice messages, music files, etc.) and may also include sound generated by applications operating on the mobile computing device 1650.

The mobile computing device 1650 may be implemented in a number of different forms. For example, it may be implemented as a cellular telephone 1680. It may also be implemented as part of a smart-phone 1682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

A biological sample punching device can be used to automatically or semi-automatically punch one or more spot samples into microtitration plates. Some biological sample punching devices include a variety of punch head sizes so that microtitration plates requiring different sample spot sizes can be punched simultaneously. The punching pattern used by a biological sample punching device, for example, may be programmed into the setup routine of the biological sample punching device.

Short range communications may be used to recognize items or retrieve information from items including electronic labels or electronic tags. In some examples, a radio frequency (RF) signal, Bluetooth®, Near Field Communication (NFC), or Wi-Fi™ based wireless connection may be established between an electronic tag and a separate computing device. Short range communications standards such as, in some examples, ISO/IEC 14442, ISO/IEC 18092, or FeliCa may be used in some circumstances to communicate information from an electronic tag to the separate computing device.

Machine readable indicia may be used to label items. The machine-readable indicia may provide an item with a unique identification number that may be used to track items and provide access to information about an item. In some examples, the machine-readable indicia may be a barcode, two-dimensional barcode, three-dimensional barcode, QR code, or matrix barcode.

In view of the structure, functions and apparatus of the systems and methods described here, in some implementations, a system for localized communication with a biological sample card transmission and storage device is provided. Having described certain implementations of methods and systems for pairing a biological sample card transmission and storage device with a software application and communicating with an item having a biological sample card transmission and storage device, it will now become apparent to one of skill in the art that other implementations incorporating the concepts of the disclosure may be used. Therefore, the disclosure should not be limited to certain implementations, but rather should be limited only by the spirit and scope of the following claims.

1. A biological sample card comprising:
one or more collection regions, each configured to stably contain a biological sample; and
a transmission and storage device comprising:
an antenna configured for short range communication, and
a computer-readable medium,
wherein the transmission and storage device is configured to:
receive patient data transmitted to the antenna,
store the patient data in the computer-readable medium, and
transmit the patient data via the antenna responsive to a query signal.

2. The biological sample card of claim 1, further comprising a barcode, wherein the transmission and storage device is programmed with a barcode identifier corresponding to the barcode.

3. The biological sample card of claim 1, wherein the transmission and storage device is further configured to encrypt the patient data.

4. The biological sample card of claim 1, wherein the one or more collection regions comprises filter paper configured to absorb the biological sample, wherein the biological sample comprises a blood sample.

5. (canceled)

6. The biological sample card of claim 1, wherein transmitting the patient data comprises encrypting the patient data.

7. The biological sample card of claim 1, comprising a perforation configured to allow separation of a first portion of the biological sample card from a second portion of the biological sample card.

8. The biological sample card of claim 7, further comprising a first barcode presented upon the first portion and a second barcode presented upon the second portion, wherein
the first barcode is identical to the second barcode; and
the transmission and storage device is programmed with a barcode identifier corresponding to the first barcode.

9. The biological sample card of claim 8, wherein the first portion comprises the one or more collection regions and the transmission and storage device.

10. The biological sample card of claim 8, wherein the second portion comprises one or more entry fields, wherein each of the entry fields is labeled to accept text information, wherein the text information comprises a non-electronic rendering of at least a portion of the patient data.

11. The biological sample card of claim 1, wherein the transmission and storage device comprises an RFID tag.

12. The biological sample card of claim 1, wherein the transmission and storage device comprises an NFC tag.

13. A method comprising:
obtaining patient data;
initiating, by a processor of a computing device, communication with a transmission and storage device contained within or upon a biological sample card, wherein the transmission and storage device is configured for short range communication;
transmitting, via an antenna of the computing device, the patient data from the computing device to the transmission and storage device, wherein the antenna is configured for short range communication; and
verifying, by the processor of the computing device, success of transmission of the patient data.

14. The method of claim 13, wherein the computing device is a handheld computing device.

15. The method of claim 13, wherein obtaining patient data comprises receiving input manually entered on the computing device.

16. The method of claim 13, wherein obtaining patient data comprises remotely receiving at least a portion of the patient data from a patient database system.

17. The method of claim 13, wherein obtaining patient data comprises scanning a computer-readable indicia with a scanner of the computing device.

18. The method of claim 13, wherein initiating communication with the transmission and storage device comprises tapping the biological sample card to the computing device.

19.-21. (canceled)

22. The method of claim 13, further comprising, prior to transmitting the patient data, applying a security algorithm to the patient data.

23. The method of claim 13, wherein verifying success of transmission comprises presenting, on a display region of the computing device, at least a portion of the patient data for review and verification.

24. The method of claim 13, wherein verifying success of transmission comprises at least one of: delivering an audible signal via the computing device; delivering a visual signal on a display of the computing device; and delivering a tactile or haptic signal via the computing device.

25.-26. (canceled)

27. The method of claim 13, wherein:
the biological sample card comprises a blood card for newborn screening; and
the patient data comprises patient birth date, patient birth time, patient birth weight, patient gender, patient ethnic code, and sample collection date.

28. The method of claim 27, wherein obtaining the patient data comprises:
presenting one or more data entry fields related to at least one of national and regional newborn screening information requirements; and
receiving user input related to each data entry field of the one or more data entry fields.

29. The method of claim 28, wherein obtaining the patient data comprises associating a new blood sample with stored patient data.

30. The method of claim 29, wherein the patient data further comprises retest information.

31. A system comprising:
a processor;
an antenna, wherein the antenna is configured for short range communication; and
a non-transitory computer-readable medium storing instructions thereon wherein the instructions, when executed, cause the processor to:
initiate communication with a transmission and storage device, wherein
the transmission and storage device is configured for short range communication, and
a biological sample card comprises the transmission and storage device,
obtain, via the antenna, patient data from the transmission and storage device, and
evaluate the patient data to identify at least one laboratory test to perform on a biological sample, wherein the biological sample card comprises the biological sample.

32. The system of claim 31, wherein evaluating the patient data comprises identifying at least one of an ethnicity, an age, a sex, an indication of premature birth, an indication of feeding type, a medication indication, and a steroid indication.

33. The system of claim 31, wherein the instructions, when executed, cause the processor to:
identify, from the patient data, a patient identifier; and
reference a patient database to identify stored patient data associated with the patient identifier.

34. The system of claim 31, wherein evaluating the patient data comprises identifying, from the stored patient data, prior test results or prior attempted testing.

35. The system of claim 31, wherein the instructions, when executed, cause the processor to identify one or more discrepancies between the patient data and the stored patient data.

36. The system of claim 31, wherein the instructions, when executed, cause the processor to determine a punching pattern for punching the biological sample card, wherein the punching pattern is based in part upon one or more of the at least one laboratory test.

37. The system of claim 36, further comprising a punching apparatus, wherein the instructions, when executed, cause the processor to cause the punching apparatus to punch the biological sample card in the punching pattern.

38. The system of claim 31, wherein the instructions, when executed, cause the processor to store, to a patient database, the patient information.

39. The system of claim 38, wherein the instructions, when executed, cause the processor to store, to the patient database, a status indicator, wherein the status indicator comprises an indication regarding at least one of sample received, sample unusable, sample abnormal, sample testing ongoing, sample testing completed, and additional sample required.

40. The system of claim 38, wherein the instructions, when executed, cause the processor to store, to the patient database, one or more test results, wherein the one or more test results are associated, within the patient database, with the patient data.

41. The system of claim 38, wherein a separate computing device comprises the patient database.

42. A non-transitory computer-readable medium, wherein the computer-readable medium stores instructions that, when executed by a processor, cause the processor to:
cause the presentation of a user interface for authentication of a user;
receive a user identifier corresponding to the user;
authenticate the user identifier;
associate user biographic information with the user identifier;
obtain patient information regarding a patient, wherein a biological sample is being collected from the patient onto a biological sample card comprising a transmission and storage device configured for short range communication;
determine sample collection information, wherein the sample collection information comprises at least a portion of the user biographic information and one or more of a date, timestamp, and location;
receive a write request;
initiate communication with a transmission and storage device;
write the patient information and the sample information to the transmission and storage device; and
verify successful transfer of the patient information and the biographic information to the transmission and storage device.

43.-44. (canceled)

45. The computer-readable medium of claim 41, wherein the instructions, when executed, further cause the processor to:
collect, from a geolocation feature of a computing device, a current location, wherein the location is based on the current location.

46. The computer-readable medium of claim 45, wherein the instructions, when executed, further cause the processor to determine an address based upon the current location, wherein the location comprises the address.

47.-48. (canceled)

49. The computer-readable medium of claim 41, wherein the instructions, when executed, further cause the processor to determine a current time, wherein the timestamp comprises the current time.

50. The computer-readable medium of claim 41, wherein the user biographic information comprises at least one of a name and a unique employee identifier.

51. The computer-readable medium of claim 41, wherein the instructions, when executed, further cause the processor to:
obtain healthcare facility information, wherein
the healthcare facility information comprises two or more of a name of a health care professional, a telephone number, an address, a hospital name, a screening laboratory name, and a screening laboratory telephone number; and
write the healthcare facility information to the transmission and storage device.

52. The computer-readable medium of claim 41, wherein the instructions, when executed, further cause the processor to provide inventory information regarding the biological sample to a computer system of a screening laboratory.

53.-70. (canceled)
